(19) United States
(12) Patent Application Publication
(10) Pub. No.: US 2014/0113144 A1
(43) Pub. Date: Apr. 24, 2014

(54) SUPERHYDROPHOBIC NANOCOMPOSITE COATINGS

(71) Applicants: Eric Loth, Charlottesville, VA (US); Adam Steele, Charlottesville, VA (US); Ilker Bayer, Arnesano (IT)

(72) Inventors: Eric Loth, Charlottesville, VA (US); Adam Steele, Charlottesville, VA (US); Ilker Bayer, Arnesano (IT)

(73) Assignee: UNIVERSITY OF VIRGINIA PATENT FOUNDATION, Charlottesville, VA (US)

(21) Appl. No.: 14/124,319

(22) PCT Filed: Jun. 8, 2012
(86) PCT No.: PCT/US2012/041574

§ 371 Date: Dec. 6, 2013

Related U.S. Application Data
(60) Provisional application No. 61/494,512, filed on Jun. 8, 2011.

(51) Int. Cl. C09D 133/16; C09D 175/04; B08B 17/06

(52) U.S. Cl. CPC C09D 133/16; B08B 17/065; C09D 175/04
USPC 428/421; 427/385.5; 524/507; 524/391; 524/446

(57) ABSTRACT

The invention relates to a superhydrophobic coating composition containing a polyurethane; a fluoropolymer; a nanofiller; and an organic solvent. The polyurethane to fluoropolymer are present in a weight ratio from about 1:2 to about 15:1. Coated substrate having at least a portion of one surface coated with a hydrophobic coating using the superhydrophobic coating composition are disclosed as are methods for forming a superhydrophobic coating on a substrate. The invention also relates to a method of forming a superhydrophobic coating on a surface of a substrate by spray casting a superhydrophobic coating composition onto a surface of a substrate to form a coating using an ultrasonic nozzle or at an air pressure of about 20 to about 60 psi and from a height of about 3 to about 12 inches above the surface to form a coating, and curing the coating.

### CROSS-REFERENCE TO RELATED APPLICATIONS

This application claims priority under 35 USC §119 to U.S. Provisional Application 61/494,512, filed Jun. 8, 2011; the disclosure of which is incorporated by reference.

### FIELD OF THE INVENTION

This invention relates to superhydrophobic nanocomposite coatings containing polyurethanes. The invention also relates to coating compositions and methods used to form the superhydrophobic nanocomposite coatings as well as substrates having those coatings on at least one surface.

### BACKGROUND OF THE INVENTION

Polyurethane coatings are used on many different materials and in a wide variety of applications due to their high durability and adaptable chemical composition. Such adaptability has led to the synthesis and commercial development of many different types of polyurethane coatings from a long list of macrodiols, diisocyanates and chain extenders.¹ Moisture cured polyurethanes (MCPUs) are one such type of polyurethanes. MCPU formulations contain isocyanate-terminated polyurethane prepolymer, which can cure with atmospheric moisture to produce highly crosslinked networks by a reaction of an excess amount of a diisocyanate, e.g. methylene diphenyl diisocyanate, with a polyol. This causes a small amount of left over isocyanate monomer to react with moisture on substrate surfaces and complete the cure.² The highly crosslinked networks of MCPU coatings have many potential advantages including superior hardness, strength, stiffness and flexibility. The surface moisture that completes the chemical reaction also allows these materials to adhere well to moist substrates and form strong chemical bonds by infiltrating surface pores and asperities where water is present. Furthermore, the probability of a weak boundary layer caused by water trapped under the coating is greatly reduced since surface moisture is consumed in the process.

The principles and properties affecting surface wetting have been studied for decades to understand physical/chemical interactions that affect the nature of the surface. It is well known that the degree to which a solid surface repels a liquid mainly depends upon two factors: surface energy and surface morphology. The surface energy affects the liquid-solid surface interface by influencing the attractive forces between the liquid and solid at the molecular scale. When a liquid such as water comes in contact with most surfaces such as wood and metal, the liquid molecules have a stronger attraction to the molecules of the solid surface than to each other (i.e. the adhesive forces are stronger than the cohesive forces) and a fluid droplet will spread out (contact angle less than 90°). If the liquid is water, this is known as a hydrophilic surface. Conversely, for some surfaces such as silicone rubber, the opposite occurs and the cohesive forces are stronger than the adhesive forces leading to a contact angle greater than 90°. Similarly, these surfaces are known as hydrophobic if the liquid is water. Surface morphology alteration, on the other hand, at the micro- and/or nano-scale can allow for an air layer to be maintained in the space between the asperities during liquid contact. This addition of surface texture alters the solid-liquid surface contact area and leads to an apparent contact angle, for a droplet on the surface. There has been and continues to be a particular interest in surfaces that are resistant to wetting by liquids. Such surfaces are referred to as hydrophobic where the liquid is water, and lyophobic relative to other liquids.

The story of superhydrophobic materials starts in nature and has been appropriately named the ‘lotus effect’ after the lotus leaf (Nelumbo nucifera). Its characteristic micro- and nano-surface morphology combined with low surface energy chemical functionality were first synthetically mimicked in the 1930s for waterproofing fabrics. Research in this area then went though a relatively uneventful period until the 1990s when nanotechnology began to prosper. Since then, many studies have been published and a wide array of approaches have been developed for creating superhydrophobic surfaces and to enable the potential of such superhydrophobic surfaces to be used in an industrial setting. Remarkable water contact angles well over 150° and contact angle hysteresis values well below 10° have been reported. High wettability resistance to other liquids such as oils and alkanes have even been reported. Some studies report relatively simple fabrication techniques for potential large surface area application. However, there are significant hurdles remaining that must be overcome before industrial application is realistic, such as environmentally friendly compositions, mechanical durability, and a better understanding of the saturation phenomenon, which voids the superhydrophobic effect. With this interest, superhydrophobic coatings and superoleophobic coatings have been prepared from a variety of materials and are know for a large variety of uses. Examples of such coatings, the coating compositions they are formed from and the numerous substrates to which they are applied have been described in: PCT Publication No. WO 2007/149617 A1, “Articles Having Durable Hydrophobic Surface;” European Patent Application No. EP 2 210 921 A1, “Superhydrophobic nano-fabrics and coatings”; U.S. Patent Application Publication No. US 2010/0068434 A1, “Composite Material Compositions and Methods”; U.S. Patent Application Publication No. US 2008/0268233 A1, “Nanotextured Super or Ultra Hydrophobic Coatings”; U.S. Patent Application Publication No. US 2007/0072991 A1, “Synthesis of Thermoplastic Polyurethane Composites;” PCT Publication No. WO 2010/042191 A1, “Highly Durable Superhydrophobic, Oleophobic and Anti-Icing Coatings and Methods and Compositions for Their Preparation”; and U.S. Patent Application Publication No. US 2010/0314575 A1, “Anti-Icing Superhydrophobic Coatings.” The disclosure of each of these is incorporated herein by reference.

Due to their ability to repel supercooled water, recent investigations revealed the ability of synthetic superhydrophobic coatings to reduce both ice accumulation and adhesion.³⁻⁶ Icing occurs when supercooled water (water in the temperature range of 0° to about −42° C.) droplets strike a solid surface. This naturally occurring phenomenon, known as “freezing rain”, “atmospheric icing” or “impact ice”, may cause disastrous losses. Supercooled water may form, for example, when water droplets pass through a layer of cold air below the freezing temperature, and freeze instantly upon striking a solid surface. Freezing rain (also referred to as “atmospheric icing”, or “impact ice”), is notorious for glazing roadways, breaking tree limbs and power lines, and causing problems on aircrafts, wind turbines, and oil drilling rigs. The icephobic nature of these superhydrophobic surfaces may provide a solution to current icing problems on aircraft, power lines and wind turbines. To assess this capability, numerous measurements have been carried out to monitor the wettability of superhydrophobic coatings at freezing surface temperatures and at low humidity. These measurements generally demonstrated a decrease in water contact angle (CA) and contact angle hysteresis (CAH) as surface temperature decreases.⁷⁻⁹ It has been hypothesized that this effect is due to water condensation on the superhydrophobic surface driven by differences between surface and air temperatures. In particular, it was suggested that condensed micro-droplets penetrate into the gaps of the micro and nano-structures, triggering a local transition from Cassie to Wenzel wetting state.¹⁰⁻¹¹ By modifying the surface chemistry and structure of the superhydrophobic surfaces, this effect can be reduced to render the surfaces “condensation resistant”.¹²⁻¹⁵ Recently, Yin et. al.¹⁶ studied condensation effects due to both surface temperature and air humidity and demonstrated a loss of superhydrophobicity in natural and artificial surfaces below 10° C. and where relative humidity was greater than 60%. However, while the performance of a freezing superhydrophobic surface in ambient conditions is well documented, there remains a need for superhydrophobic nanocomposite coatings which withstand degradation due to changes in temperature and humidity.

The goal then is to engineer and form synthetic superhydrophobic surfaces to provide solutions in areas such as anti-corrosion/fouling surface applications, icing protection on aircraft, power lines and wind turbines as well as drag reduction in marine and fluid powered systems. Since discovering that nano and micro length scale surface morphology as a key parameter for superhydrophobicity, researchers have been successful in fabricating various synthetic surfaces that are highly water repellent. Fabrication methods include surface etching techniques (plasma, laser, chemical), lithography (photolithography, electron beam, X-ray), electrochemical deposition processes as well as electrospinning techniques.¹⁷⁻¹⁸ However, since the prior fabrication techniques involve expensive and restrictive fabrication processes, it is both uneconomical and impractical to adopt these fabrication methods for realistic large-area applications. To resolve this problem, researchers have recently employed a spray-casting technique in which a nanoparticle-polymer suspension is atomized and dispersed on a surface using an air-atomizing spray nozzle.¹⁹⁻²⁵ This creates a superhydrophobic nanocomposite coating fabricated from a simple one-step process which can be applied to a large area and to a variety of substrate materials. Although the mechanism for the formation of superhydrophobic nanocomposites by spray atomization has been documented¹⁹, a need still exists to optimize spray deposition parameters on the superhydrophobic performance and mechanical durability of the coating. Understanding these effects is needed for large-scale manufacturing applications where coatings of consistent durability and superhydrophobicity are desired.

There is a need in the art for nanocomposite coatings with properties such as increased adhesion strength, superhydrophobicity, anti-icing, and anti-wetting, particularly for wind turbine surfaces. There is also a need for a manufacturing process to systematically fabricate superhydrophobic coatings from different spray-casting heights and air pressures. This invention answers such needs.

### SUMMARY OF THE INVENTION

The invention relates to superhydrophobic coating compositions containing about 5 to about 60 weight percent of a polyurethane, about 5 to about 60 weight percent of a fluoropolymer, about 5 to about 50 weight percent of a nanofiller, about 25 to about 99 weight percent of an organic solvent, and up to about 15 weight percent water. The polyurethane and the fluoropolymer are present in a weight ratio from about 1:2 to about 15:1.

The invention also relates to coated substrates having at least a portion of one surface coated with a superhydrophobic coating. The superhydrophobic coating formed on the surface contains about 15 to about 80 weight percent of a polyurethane, about 5 to about 80 weight percent of a fluoropolymer, and about 5 to about 40 weight percent of a nanofiller. The polyurethane to fluoropolymer are present in a weight ratio from about 1:2 to about 15:1. In one embodiment, the superhydrophobic coating has a static water contact angle above 150° and contact angle hysteresis value below 8°.

The invention also relates to methods of forming a superhydrophobic coating on a substrate. In one embodiment, a method forms a superhydrophobic coating on a surface of a substrate by spraying a superhydrophobic coating composition of any one of claims 1-6 onto a surface of a substrate to form a coating, and curing the coating. In another embodiment, a method of forms a superhydrophobic coating on a surface of a substrate by spray casting a superhydrophobic coating composition onto a surface of a substrate to form a coating from a height of about 3 to about 12 inches above the surface to form a coating, and curing the coating.

### BRIEF DESCRIPTION OF THE FIGURES

FIG. 1 is a schematic representation of fluoropolymer, e.g., PMC, dispersion within the polyurethane, e.g., MCPU, network with subsequent solvent evaporation from the coating and polymer crosslinking to form an interpenetrating polymer network.

FIG. 2 depicts (a) the dependence of apparent static water contact angle on the nanoclay concentration as well as MCPU/PMC weight ratio and, (b) the dependence of contact angle hysteresis throughout the surface area for select MCPU/PMC weight ratios and an 11% nanoclay weight concentration.

FIG. 3 shows, using a superhydrophobic nanocomposite coating with 11% nanoclay weight concentration, the dependence of (a) apparent static water contact angle over twelve 1750 N/m tape tests and (b) contact angle hysteresis after the twelfth tape test for select MCPU/PMC weight ratios.

FIG. 4 provides SEM images of (a) surface morphology of the superhydrophobic MCPU/PMC/nanoclay nanocomposite coating, (b) the surface structure detail showing the appearance of self-similar inherently rough micro-bumps, and (c) magnified image of the nanoscale roughness features on the micro-bumps.

FIG. 5 provides representative SEM images of (a) superhydrophobic nanocomposite coating before tape testing and (b) the same superhydrophobic nanocomposite coating after twelve tape tests for an adhesion strength of 3850 N/m.

FIG. 6 provides (a) an SEM image detecting backscattered electrons of a superhydrophobic MCPU/PMC/nanoclay nanocomposite coating to show chemical uniformity and, (b) an energy dispersive spectroscopy plot for the coating.

FIG. 7 shows, using a superhydrophobic nanocomposite coating with 11% nanoclay weight concentration and 1:1 MCPU/PMC weight ratio, the dependence of (a) apparent static water contact angle over twelve tape tests for select adhesion strengths and (b) contact angle hysteresis after the twelfth tape test.

FIG. 8 provides SEM images of the superhydrophobic nanocomposite coatings at magnifications of (a) 200× (b) 3000×.

FIG. 9 provides a schematic illustration of an experimental setup for thermally homogeneous, high and low humidity tests.

FIG. 10 depicts the superhydrophobic performance of nanocomposites for a temperature cycle (20° C. to −3° C. to 20° C.) while maintaining thermal homogeneity at each point of measurement (a) CA at low humidity (b) ROA at low humidity (c) CA at high humidity (d) ROA at high humidity.

FIG. 11 depicts the homogeneous vs. non-homogeneous thermal effects on the superhydrophobicity of the nanocomposites.

FIG. 12 is a schematic illustration of a system configured to carry out a spray-casting process.

FIG. 13 depicts the effect of spray-casting height on super-hydrophobicity of the nanocomposite coating (spray-casting air pressure fixed at 60 psi).

FIG. 14 provides SEM images of nanocomposite coatings spray-casted at a height of (a) 2 inches (b) 3 inches.

FIG. 15 depicts the effect of spray-casting air pressure on superhydrophobicity of the nanocomposite coating (spray-casting height fixed at 3 inches).

FIG. 16 depicts the effect of spray-casting height on mechanical durability of nanocomposite coating (spray-casting pressure fixed at 60 psi.

FIG. 17 depicts the effect of spray-casting pressure on mechanical durability of nanocomposite coating (spray-casting height fixed at 3 inches).

### DETAILED DESCRIPTION

The invention relates to superhydrophobic coatings. The term “superhydrophobic” refers to a surface or coating that is extremely difficult to wet with water. A superhydrophobic surface or coating will usually have static water contact angle of at least 150°. In addition to high contact angle, superhydrophobic surfaces also have very low water contact angle hysteresis below 10°, which is the difference between the advancing and receding contact angles. A liquid droplet exhibits an advancing contact angle when additional liquid is added to a sessile droplet causing the volume to increase and the solid-liquid contact line to advance. Similarly, if liquid is removed from the droplet causing the volume to decrease, the contact line recedes and the receding contact angle can be observed. Alternatively, if a surface is tilted and a droplet moves along the solid surface, the advancing contact angle can be observed at the front of the droplet, and is greater than the receding contact angle which can be observed at the back of the droplet. Although it has been debated whether or not the two definitions are equivalent, in many cases, especially for superhydrophobic surfaces, the two approaches yield very similar results. Surfaces that exhibit contact angle hysteresis lower than 10° to a particular liquid cause droplets to roll and bounce almost freely on the surface, causing a very low water roll-off angle (also sometimes referred to as tilt or sliding angle) which denotes the angle to which a surface must be tilted for droplets to roll or slide. The invention provides superhydrophobic coating compositions, a substrate or a surface of a substrate coated with a superhydrophobic coating of the invention, as well as methods of forming a superhydrophobic coating.

Although there are a number of reports on the fabrication of superhydrophobic coatings with a polyurethane component²⁶⁻³⁰ (see also, e.g., U.S. Published Application 2007/0072991), the inventors are not aware of any publications which have examined and optimized its influence with regard to adhesion strength and anti-wetting performance. In fact, adhesion strength is typically not discussed or even mentioned in studies on superhydrophobicity³¹⁻³⁴ because the vast majority of synthetic superhydrophobic coatings are extremely fragile. Only recently have some researchers started to consider substrate adhesion characteristics when creating superhydrophobic nanocomposite coatings.³⁵⁻³⁸ Similarly, investigation into the mechanical durability of superhydrophobic surfaces in general is only now beginning.³⁹

Superhydrophobic Coating Compositions of the Invention

A superhydrophobic coating composition of the invention used to form a superhydrophobic coating comprise about 5 to about 60 weight percent of a polyurethane; about 5 to about 60 weight percent of a fluoropolymer; about 5 to about 50 weight percent of a nanofiller; about 25 to about 99 weight percent of an organic solvent. In one embodiment a superhydrophobic coating composition may comprise 10 to 20 weight percent of a polyurethane; about 10 to about 20 weight percent of a fluoropolymer; about 5 to about 30 weight percent of a nanofiller; about 50 to about 75 weight percent of an organic solvent. As discussed below, a superhydrophobic coating composition of the invention may contain up to about 15 weight percent water. The polyurethane and fluoropolymer are present in a weight ratio from about 1:2 to about 15:1. In one embodiment the polyurethane and fluoropolymer are present in a weight ratio from about 1:2 to about 5:1, or a weight ratio of about 1:1 or about 14:1. The components and preparation of the superhydrophobic compositions of the invention are described below.

Concentrations of the polyurethane, fluoropolymer and nanofiller to create superhydrophobic performance may be determined by measuring static contact angle and hysteresis in relation to component weight percentage. Superhydrophobic surfaces are characterized by static water contact angles above 150° and contact angle hysteresis values below 10°. This combination leads to small droplets that remain nearly spherical on the surface, causing them to roll and bounce freely so as to be both anti-wetting and self-cleaning. One preferred embodiment of the invention relates to superhydrophobic coatings of the invention having a static water contact angle above 150° and contact angle hysteresis value below 8°. Superhydrophobicity can be achieved using a relatively low nanofiller concentration, after which mechanical durability and adhesion performance may degrade for higher amounts.³⁹

Superhydrophobic coating compositions of the invention may also contain other additives known in the art for coating compositions such as curing agents, pigments, antiseptics, conductivity additives, etc. Other common additives include but are not limited to one or more leveling, rheology, and flow control agents such as silicones, fluorocarbons or cellulosics; extenders; reactive coalescing aids such as those described in U.S. Pat. No. 5,349,026, incorporated herein by reference; plasticizers; flatting agents; pigment wetting and dispersing agents and surfactants; ultraviolet (UV) absorbers; UV light stabilizers; tinting pigments; colorants; defoaming and antifoaming agents; anti-settling, anti-sag and bodying agents; anti-skinning agents; anti-flooding and anti-floating agents; biocides, fungicides and mildewcides; corrosion inhibitors; thickening agents; or coalescing agents. Specific examples of such additives can be found in Raw Materials Index, published by the National Paint & Coatings Association, 1500 Rhode Island Avenue, N.W., Washington, D.C. 20005. These common additives may be incorporated into the coating compositions in the manner and amounts known in the art.

Polyurethanes

Polyurethanes are polymers consisting of a chain of organic units joined by urethane (carbamate) linkages. Polyurethane polymers are typically formed through polymerization of at least one type of monomer containing at least two isocyanate functional groups with at least one other monomer containing at least two hydroxyl (alcohol) groups and optionally, a chain extender. A catalyst may be employed to speed the polymerization or curing reaction. In some embodiments, the polyurethane employed in the superhydrophobic coatings may be formed from a polyisocyanate and a mixture of —OH (hydroxyl) and NH (amine) terminated monomers. In such systems the polyisocyanate can be a trimer or homopolymer of hexamethylene diisocyanate.

Any suitable polyurethane that has isocyanate (—NCO) groups available for reaction may be used in a superhydrophobic coating and coating composition of the invention. Polyurethane coatings are known to be compatible with, and show good adhesion to, a wide variety of surfaces. Using polyurethane binders superhydrophobic coatings of the invention may be formed on virtually any surface, including but not limited to, those of metals, glass, ceramics, concrete, wood, and plastics.

One class of polyurethanes that may be used in the superhydrophobic coatings and coating compositions of the invention are “moisture cure polyurethanes” (MCPU's) which are capable of self-crosslinking. MCPU's are typically one-component coating compositions. Contact between an isocyanate moiety of the MCPU and a water molecule produces an amine moiety capable of bonding with an isocyanate moiety of another urethane binder molecule in a linear polymerization reaction. In certain aspects, a moisture cure urethane coating is baked at 100° C. to 140° C., including all intermediate ranges and combinations thereof, to promote crosslinking reactions between the linear polymers. MCPU's, which are known in the art and commercially available, have been described in, for example, U.S. Pat. Nos. 6,245,877 and 6,355,317 as well as US Published Patent Applications 2008/0119629 A1 and 2010/0247334 A1. Suitable isocyanates may include, but are not limited to, methylene diphenyl diisocyanate, toluene diisocyanate, hexamethylene diisocyanate, and isophorone diisocyanate. Suitable polyols may include, but are not limited to, polyethers, polyesters, and hydroxyl-terminated polybutadiene. A particular example of an MCPU useful in the invention is a one-component liquid formula comprising 25% diphenylmethane-diisocyanate and 75% polyurethane pre-polymer (hexanedioic acid, polymer with 1,6-hexanediol and 1,1-methylenebis 4-isocyanatobenzene). This type of polyurethane formula is commonly found in many commercially available adhesives such as Titebond and Gorilla brand adhesives.

A polyurethane which may be used is the Imron AF3500 product available from DuPont. Imron AF3500 is a polyester-aliphatic/isocyanate polyurethane. As with other commercial polyurethanes, the Imron AF3500 product contains 2 parts per volume polyurethane, 1 part per volume Urethane Activator, 0.25 parts per volume Pot Life Extender, and 0.25 parts per volume Reducer. See Imron AF3500 product data sheet, E. I. DuPont de Neumors and Company, Inc. 2004.

Any polyurethane, such as an MCPU, or other polyurethane, used in a superhydrophobic coating or coating composition of the invention may be used as formulated in a commercial product. As with the Imron AF3500 product, a polyurethane composition may contain typical polyurethane additives which include, but are not limited, as an activator, a pot life extender, a reducer, a curing agent, and other additives known in the art.

A superhydrophobic coating compositions of the invention may optionally include a crosslinking catalyst, which allows the polyurethane curing to occur quickly. Suitable catalysts include those known in the urethane art for catalyzing the reaction of NCO groups, particulalry with water. Preferred catalysts are tertiary amine, organozinc, and organotin compounds such as stannous octoate, dibutyltin dilaurate, and the like. The amount of catalyst used depends on many factors, but it is typically present in an amount within the range of about 0.0001 to about 2 wt %.

Fluoropolymers

A superhydrophobic coating or coating composition of the invention also contains a fluoropolymer. The low surface energy of fluoropolymers causes them to be hydrophobic as well as providing oil and water repellency, and stain resistance to coatings containing them. The fluoropolymer is a homopolymer or copolymer containing a polyfluorinated monomer of the following structure:

R_{f}—O—C(O)—C(R)═CH—R (I)

in which R_{f} represents a linear or branched chain fluorinated radical containing 1 to 20 carbon atoms, preferably 1 to 12 carbon atoms or 1 to 6 carbon atoms, R one of the symbols R represents a hydrogen atom and the other a hydrogen atom or an alkyl radical containing 1 to 4 carbon atoms. The polyfluorinated radical R_{f} is CₙHₓF₍₂ₙ₊₁₋ₓ₎, in which n ranges from 1-20 and x is defined to 0≦x≦n, where for perfluoromonomers, x has the value of 0.

A fluoropolymer used in the invention may be selected from the group of a perfluoroalkyl acrylic (co)polymer, perfluoroalkyl methacrylic (co)polymer, and mixtures thereof. Common co-monomers include, for example, the corresponding non-fluorinated acrylic and methacrylic monomers as well as other vinylic monomers. See, e.g., US Published Patent Application 2004/0077758 A1. Such fluoropolymers are commercially available, for example those previously sold under the “ZONYL” trade name and now under the “CAPSTONE” trade name by E.I. du Pont de Nemours and Company, Wilmington, Del., USA. Selected examples of useful fluoropolymers include, but are not limited to, Zonyl® 8740/Capstone® ST-110, Zonyl® 321/Capstone® ST-100HS, Zonyl® 329, Zonyl® 9373, Capstone® ST-200, Capstone® ST-300, and Capstone® ST-500 products. Particularly suitable are the Zonyl® 8740/Capstone® ST-110 and Zonyl® 321/Capstone® ST-100HS products.

Commercially available fluoropolymers, such as the Zonyl®/Capstone® products, may be packaged as aqueous-based products. For example, the Zonyl® 8740/Capstone® ST-110 fluoropolymer is diluted to a 30 wt %/10 wt % (respectively) product in water. Commercially available fluoropolymer products may be used in a superhydrophobic coating or coating composition as formulated by the manufacturer and may contain common additives known in the art for those formulations.

Nanofillers

The nanofiller used in a superhydrophobic coating or coating composition of the invention are particulate materials with a particle size ranging from about 1 nm to about 500 μm. In one embodiment the particle size may range from about 10 nm to about 5 μm. The particles can be spheroidal or non-spheroidal, e.g., irregularly shaped particles. The term “average particle size” refers to the size of primary particles, as they would be classified by means known in the art, and is not the size of agglomerates. Particle size is generally the average diameter of a spheroidal particle and approximately the largest dimension of an acicular particle.

The nanofiller may be clay particles, metallic particles, oxides, carbon particles synthetic particles or mixtures thereof. Mixtures of nanofillers may be used in the superhydrophobic coatings and coating compositions of the invention. The nanofiller may be porous or non-porous. Preferably, the nanofiller material used in coatings and coating compositions of the invention is itself hydrophobic. Examples of suitable clay nanofiller materials include, but are not limited to, montmorillonite clay, talc, bentonite, kaolinite and others known in the art. Examples of suitable of oxide nanofiller materials include, but are not limited to, silica, alumina, titanium oxide, zirconium oxide, antimony oxide, zinc oxide, tin oxide, indium oxide, cerium oxide, mullite (alumina silicate); other oxides such as iron oxide, nickel oxide, oxides of refractory metals such as molybdenum, niobium, and tungsten, and complex oxides created from co-precipitation or oxidation of complex oxides. Examples of suitable synthetic nanofiller materials include, but are not limited to, polystyrene particles, (meth)acrylates particles, PTFE particles, polyolefin particles, polycarbonate particles, polysiloxane particles, silicone particles, polyester particles, polyamide particles, and polyurethane particles, as well as nanofibers, nanotubes, or nanowires, particularly carbon nanofibers, nanotubes, or nanowires. A clay nanofiller for a nanocomposite coating is of interest in that it can be highly desirable as it incorporates an environmentally and biologically friendly material, which may not be true for other nanofiller materials used for superhydrophobic surfaces, such as carbon nanotubes.⁴⁰

The nanofiller particles, as is known in the art, may be surface treated to adjust its hydrophobicity, its compatibility with the other components of the superhydrophobic coating or coating composition or its ability to bind to the surface being coated. The nanofiller particles used in the coatings or coating compositions of the invention may be surface-modified with compounds that make the surface of the particles more hydrophobic or compatible with other components of the coating. Examples of compounds used to increase hydrophobicity include, for example, organosilanes, such as polydimethylsiloxane, hexamethyldisilizane, octyltrimethoxysilane, and dimethyldichlorosilane, as well as other compounds that possess a hydrophobic chain, e.g. alkyl chain or fluorocarbon chain as is known in the art. In one embodiment, as an example, the nanofiller may be fatty amine/amino-silane surface modified montmorillonite clay particles such as the Nanoclay available from Nanocor Inc., USA.

Organic Solvents

The superhydrophobic coating compositions of the invention are formulated with an organic solvent. Organic solvents useable in the compositions are those with a boiling point that allows for evaporation during a spray-coating process. The boiling point (bp) of the organic solvent should be less than about 85° C. Suitable solvents include, for example, ethanol (bp 78.4° C.), iso-propanol (bp 82.5° C.), acetone (bp 56-57° C.), and ethylacetate (bp 77.1° C.). Mixtures of organic solvent can also be used. The surface tension of the solvent may also be low to avoid the coffee stain effect upon curing and lead to an even coating. A superhydrophobic coating composition of the invention, in addition to the organic solvent may also contain water. Any water is present in an amount up to about 15 weight percent, up to about 10 weight percent or up to about 5 weight percent. In one embodiment, water may be present in an amount ranging from about 5 to about 10 weight percent.

As discussed below, a superhydrophobic coating of the invention is formed by spaying the superhydrophobic coating composition onto to a surface of a substrate. The organic solvent, e.g. ethanol, concentration in a superhydrophobic coating composition of the invention may also be tailored to suit the particular spray applicator used if necessary in order to obtain a “dry” spray coating and counteract the coffee stain effect.⁴¹

Preparation of Superhydrophobic Coating Compositions

A superhydrophobic coating composition of the invention is prepared by dispersing or dissolving the components of the coating in the organic solvent. Each component may be first dispersed or dissolved in the organic solvent and then the solvent mixtures combined to form the coating composition. Alternatively, if using a liquid commercial product of the polyurethane or fluoroalkyl, it may not be necessary to first that product in the organic solvent. Strong mixing, for example, using a Vortex mixer, a sonicator or other mixers used for coating formulations, is generally required to mix the components and uniformly disperse the nanofiller material. In one embodiment, the nanofiller and the polyurethane may be separately dispersed in the organic solvent, then combined with mixing, followed by slow addition, with mixing, of a liquid formulation of the fluoropolymer. The coating composition should be mixed using conditions sufficient to form a homogeneous dispersion of the components in the organic solvent. Additional organic solvent can be added to adjust the concentration or viscosity of the final dispersion prior to spray-coating.

Exemplary superhydrophobic coating compositions of the invention may be made by one of the following methods:
a) first 4 g of Nanoclay and 4.5 g MCPU were separately dispersed in two vials of 10 mL ethyl alcohol. Then each dispersion was blended together via vortex mixing or sonicating, and finally 15 g of the PMC suspension, Zonyl® 8740, was slowly added and dispersed via vortex mixing or sonicating;
b) first mix Imron AF3500 product (2.05 g polyurethane, 1.35 g Urethane Activator, 0.25 g Pot Life Extender, 0.35 g Reducer and vortex mix). Then add 10 g acetone and vortex mix again. Then add 2 g Nanoclay and vortex mix again. Then add 2.5 g Capstone® ST-110 and vortex mix again. Finally add 10 g more acetone and sonicate for 2-3 minutes; and
c) use the procedure described in part a) or b) except substitute 2 g Nanoclay with 1 g silicon dioxide (SiO₂) nanoparticles and 1 g Nanoclay.

Superhydrophobic Coating Formation

The invention also relates to a method for forming a superhydrophobic coating formulation on a substrate and a substrate coated with a superhydrophobic formulation. In one embodiment, the invention relates to a method of forming a superhydrophobic coating on a surface of a substrate, comprising the steps of spraying a superhydrophobic coating composition of the invention onto a surface of a substrate to form a coating, and curing the coating. The superhydrophobic coating contains the non-liquid components of the coating composition (e.g. the polyurethane, fluoropolymer, nanofiller, other additives but not the organic solvent or water) and those non-liquid components are present in amounts corresponding to their dry weight percentages in the superhydrophobic coating composition. An embodiment of the invention corresponds to a coated substrate having at least a portion of one surface coated with a superhydrophobic coating. The superhydrophobic coating contains about 15 to about 80 weight percent of a polyurethane, about 5 to about 80 weight percent of a fluoropolymer and about 5 to about 40 weight percent of a nanofiller. In one embodiment, the superhydrophobic coating formulation contains about 30 to about 60 weight percent of a polyurethane, about 10 to about 30 weight percent of a fluoropolymer and about 20 to about 40 weight percent of a nanofiller. The polyurethane to fluoropolymer are present in a weight ratio from about 1:2 to about 15:1. In one embodiment the polyurethane and fluoropolymer are present in a weight ratio from about 1:2 to about 5:1, or a weight ratio of about 1:1 or about 14:1.

The superhydrophobic coatings of the invention can be applied to virtually any substrate to provide a superhydrophobic surface. The choice of coatings and coating process that will be used may be affected by the compatibility of the substrate and its surface to the coating process and the component of the coating compositions. Coatings may take any desired shape or form, limited only by the manner and patterns in which they can be applied. In some embodiments, the coating will completely cover a surface. In other embodiments the coatings may cover only a portion of a surface, such as one or more of a top, side or bottom of an object. In one embodiment, a coating may be applied as a line or strip on a substantially flat or planar surface.

As discussed a superhydrophobic coating of the invention may be formed on a wide variety of substrates including but not limited to metals (such as, for example, including aluminum and its alloys, steels, galvanized steel, stainless steels, copper and its alloys, titanium and its alloys); plastics (such as, for example, polyethylene, polypropylene, nylon, silicone rubber, PVC, polystyrene, polyurethane), glass, natural polymers (such as, for example, wood (cellulose), textiles, polysaccharides, proteins, paper); ceramics, and composites. Representative articles having surfaces that may benefit from being durably superhydrophobic include architectural surfaces, vehicle surfaces, marine vessel surfaces, and signage. Non-limiting examples of applications for architectural surfaces include windows, surfaces vulnerable to graffiti such as walls or bridges, and the like. Non-limiting examples of applications for vehicles include automotive parts such as windows, body parts, mirrors, wheels, light assemblies, and the like; airplane parts such as windows, anti-icing coatings for wings or tail assemblies, wheels, light assemblies and the like; wind turbine parts such as blades and housings. Non-limiting examples of applications for marine vessels include windows, hull applications such as anti-algae coatings, drag reduction coatings for reducing fuel consumption, anti-icing coatings for reducing ice buildup and the like. Non-limiting examples of signage applications include self-cleaning or anti-dew surfaces, such as retroreflective signs and the like.

Coating methods and compositions/treatments are provided that impart a variety of desirable characteristics to objects and their surfaces, including superhydrophobicity, oleophobicity (oil repellency), anti-fouling, anti-erosion and anti-icing. The inclusion of coating additives known in the art or the choice of a particular nanofiller (e.g., zinc oxide particles for UV absorption) can be used to impart other desirable properties to the superhydrophobic coatings of the invention. Those characteristics can result in objects and surfaces with a variety of desirable properties including, but not limited to, resistance to: wetting, corrosion, swelling, rotting, cracking or warping, exfoliation, fouling, dust and/or dirt accumulation on surfaces (self cleaning), and surface ice formation adherence and accumulation. The coating compositions and treatments not only provide hydrophobicity and/or oleophobicity and/or anti-icing properties, but are durable in that they resist mechanical abrasion while retaining those properties. In one aspect, the superhydrophobic coating formed by a composition of the invention has at least one property selected from the group consisting of increased adhesion strength, increased anti-wetting, increased anti-icing, superhydrophobicity, increased freezing durability, increased self-cleaning, increased anti-fouling, increased anti-erosion, increased oil repellency, increased durability, and increased water repellency.

The coatings may be applied using a variety of techniques that can be grouped into at least three categories, including, but not limited to: one-step processes; two-step processes; and thermal deposition processes, which may in some instances be considered a special case of one-step or two-step processes. Within each of those categories numerous variations and embodiments are provided. In one embodiment, a superhydrophobic coating of the invention may be formed by spray-casting a superhydrophobic coating composition of the invention onto at least one surface of a substrate under sufficient conditions to form a superhydrophobic coating on the surface. Any spray-casting apparatus known in the art may be used, including spray-casting apparatus with ultrasonic nozzles. In one embodiment the coating composition is spray-casted as a single coating composition. In another embodiment, two or more dispersions or solutions of components may be fed into a mixing chamber within the sprayer to mix and then be sprayed as one coating composition onto a surface. For example, a dispersion of the polyurethane and the nanofiller may be fed as one stream to the mixing chamber of the sprayer and a liquid formulation of the fluoropolymer fed as another stream into the mixing chamber. After mixing the, resulting coating composition is then spray-cast onto the substrate.

In a separate embodiment of the invention, a superhydrophobic coating may be formed by spray casting at an air pressure ranging from about 20 to about 100 psi and a spray height ranging from about 2 to about 16 inches above the surface to be coated. As shown in the examples below, these two spray-casting parameters interact and may be varied to relative to one another to form a superhydrophobic coating. In one embodiment, a superhydrophobic coating may be prepared by spray casting at an air pressure ranging from about 20 to about 60 psi and from spray height ranging from about 3 to about 12 inches above the surface to be coated. Accordingly, the invention provides a method of forming a superhydrophobic coating on a surface of a substrate, comprising the steps of spray casting a superhydrophobic coating composition onto a surface of a substrate to form a coating at an air pressure of about 20 to about 60 psi and from a height of about 3 to about 12 inches above the surface to form a coating, and curing the coating. This method may be practiced with the superhydrophobic coating compositions of the invention as well as with others known in the art. Not to be bound by theory but spray-casting within these parameters facilitates a portion of the solvent within the spray mist evaporating before impacting the substrate while maintaining a sufficient dispersion to allow a substantially uniform superhydrophobic coating to form on the surface. At lower spray-casting heights, there is insufficient time for the solvent to evaporate in flight and the solvent evaporates mainly on the substrate, therefore creating a “wet” coating on the substrate. This leads to the “coffee stain” effect which causes non-uniform coatings through surface tension effects. Therefore, this results in a decrease in superhydrophobicity. In one embodiment, the spray-casting method forms a superhydrophobic coating with substantially no “coffee stain effect.” On the other hand, at higher spray-casting heights, most of the solvent evaporates during time of flight, leaving a high concentration of nanofiller and polymer components on the substrate to form a more porous nanocomposite coating with hierarchal nanotextured surface morphology and with high superhydrophobicity.

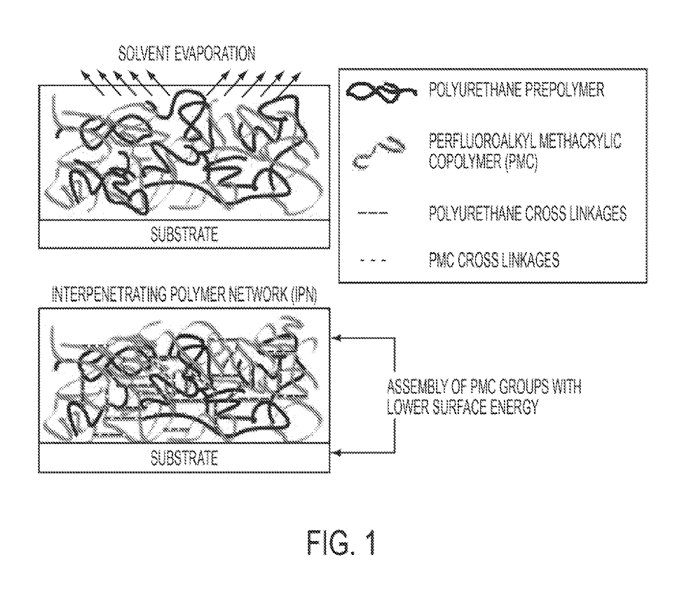

Upon curing a superhydrophobic coating composition of the invention forms a superhydrophobic coating with an interpenetrating polymer network. See FIG. 1. The superhydrophobic coating possesses improved adhesion strength as a result of the polyurethane and fluoropolymer curing, e.g., MCPU and PMC curing, to form an interpenetrating polymer network as shown schematically in FIG. 1. Unlike in previous work³⁸ where the semi-interpenetrated polymer blends could potentially be separated from the constituent polymer network without breaking chemical bonds, here the network cannot be separated without breaking bonds. Additionally, the cross linking mechanism particular to MCPUs strongly depends on the availability of adsorbed moisture on surfaces on which they are applied.² Therefore, MCPUs form very strong adhesive forces on metals and ceramics which carry naturally adsorbed moisture on their surfaces. Natural metal oxide layers also exist on metal surfaces under ambient conditions. Thus, the presence of metal hydroxides on the aluminum surface initiates the cross linking mechanism, causing initiation sites for the cross linking reactions of the polyurethanes, particularly MCPUs, via strong hydrogen bonding.⁴² Prior roughening of the surfaces may increase the adhesion strength since more surface area per unit volume becomes available for the initiation of cross linking. The aluminum substrates used in the examples below were not roughened a priori to maintain more consistent substrate surfaces for the varying coating formulations. Finally, because the interpenetrating polymer network is entangled in such a way that the two polymer components are linked and cannot be pulled apart (but not chemically bonded), it also exhibited improved cohesion as shown in the examples below.

### EXAMPLES

The following examples describe compositions and methods discovered and disclosed herein in a study to investigate substrate adhesion for superhydrophobic coatings fabricated from MCPU modified with waterborne perfluoroalkyl methacrylic copolymer (PMC) and a fatty amine/amino-silane surface modified montmorillonite clay nanofiller (nanoclay). Recent studies have shown that polyurethane-nanoclay nanocomposites can have improved thermal stability and barrier properties compared to pristine polyurethane elastomers.⁴³ The main reason for the improved performance originates from the nanoscale dispersion of nanoclay, and from the strong interactions between exfoliated silicate layers and the polyurethane matrix.⁴⁴ Nanoclay has also shown strong compatibility with rubber and fluoroacrylic superhydrophobic approaches.³⁹

According to the invention, the inventors have found that a nanofiller, in one embodiment nanoclay, can be a compatible nanofiller to additionally induce suitable nanoscale structure in a fluoropolymer-polyurethane matrix to create superhydrophobic nanocomposites coatings with improved substrate adhesion. As shown in the examples, substrate adhesion was investigated experimentally for superhydrophobic coatings fabricated from polyurethane modified with a fluoropolymer, e.g., a waterborne perfluoroalkyl methacrylic copolymer and a (fatty amine/amino-silane surface modified) montmorillonite clay nanofiller. The superhydrophobic coatings disclosed herein and described below were applied by spray casting precursor solutions onto aluminum surfaces. Upon thermosetting, initial static water contact angles exceeding 160° and contact angle hysteresis values below 8° were measured, yielding anti-wetting and self-cleaning characteristics. Adhesion strength was characterized with a 90° tape testing method and was analyzed with respect to changes in surface morphology via electron microscopy as well as changes in superhydrophobic characteristics. High contact angles and low hysteresis could be completely retained under 1750 N/m adhesion strength testing, with significant resistance as high as 3850 N/m.

The following abbreviations are used in the examples described below:

MCPU—moisture cured polyurethane. The MCPU used was a one-component liquid formula comprising 25% diphenylmethane-diisocyanate and 75% polyurethane pre-polymer (hexanedioic acid, polymer with 1,6-hexanediol and 1,1-methylenebis 4-isocyanatobenzene). Its viscosity was measured to be ˜4200 mPas at 25° C. (OFITE 90, OFI Testing equipment).

PMC— perfluoroalkyl methacrylic copolymer. The PMC used was a waterborne perfluoroalkyl methacrylic copolymer (30% wt polymer, 70% wt water) sold by DuPont under the Zonyl tradename.

### Example 1

### Superhydrophobic Nanocomposite Coatings of the Invention

1.1 Preparation of Coating Composition

Nanoclay particles, dimethyl dialkyl C₁₄-C₁₈ amine-functionalized montmorillonite clay particles, (available from Nanocor Inc., USA) was first dispersed in ethyl alcohol at room temperature. The PMC was added slowly to the nanoclay dispersion and blended with vortex mixing. All dispersions were carried out with vortex mixing (standard heavy duty model, Fisher Scinetific) for 5 minutes unless otherwise specified. Separately, the MCPU was also dispersed in ethyl alcohol. The nanoclaynanoclay/PMC dispersion was blended into the MCPU dispersion and vortex mixed, creating a Pickering emulsion. Finally, the PMC suspension was added slowly to the solution and dispersed. The final emulsion was stirred using a vortex mixer for 15 min until the mixture was in a homogenous and stable state. The amount of each component in the coating compositions is shown in Table 1.

TABLE 1

| | | | MCPU/ | | |
|---|---|---|---|---|---|
| | | PMC (30 wt % | PMC | | |
| Coating | | polymer, 70 wt % | weight | | |
| Composition | MCPU | water) | ratio | Nanoclay | Ethanol |
| 1 | — | 30 g | — | 4 g | 10 ml |
| 2 | 3 g | 20 g | 0.5 | 4 g | 10 ml |
| 3 | 4.5 g | 15 g | 1 | 4 g | 10 ml |
| 4 | 6 g | 10 g | 2 | 4 g | 10 ml |
| 5 | 9 g | — | — | 4 g | 10 ml |

1.2 Formation of a Superhydrophobic Nanocomposite Surface

The emulsions prepared in 1.1 were spray cast onto aluminum substrates using an internal mix, double-action airbrush atomizer (model VL-SET, Paasche). The aluminum substrates were coated with a single spray application from a distance of approximately 30 cm above the substrate and then heat cured at 100° C. overnight.

1.3 Wettability Performance

To assess the wettability performance of the cured nanocomposite surfaces, the apparent contact angle and hysteresis of 10 mL droplets were measured. A goniometer (model CAM 200, KSV Instruments) was used to measure the static contact angle, and a high-speed digital camera (Motion Pro X, Red Lake) was used for dynamic advancing and receding contact angle measurements. Superhydrophobic surfaces are characterized by static water contact angles above 150° and contact angle hysteresis values below 10°. This combination leads to small droplets that remain nearly spherical on the surface, causing them to roll and bounce freely so as to be both non-wetting and self-cleaning. A scanning electron microscope (SEM) was also used to characterize the surface morphology and composition (JEOL 6700F). Finally, 90° tape test measurements were made with an Instron 3300 tensile tester at a rate of 2 mm/s, as described in Bayer, et al.⁴³ Tape test measurement results were averaged over five rectangular samples. Six adhesive tapes with different adhesion strengths were procured from 3M, USA. According to the manufacturer specifications, the adhesion strength of the tapes are 440, 600, 820, 1750, 2100 and 3850 N/m reported as adhesion to steel. The tapes are made up of polyester backing material and a proprietary rubber adhesive layer. The tapes were cut into 7 cm pieces and were applied and pressed on each surface by hand ensuring that no large air pockets were trapped between the tape and the surfaces. One end of the tape (about 5 mm in length) was not pressed on the surface so that it could be attached to the grip (a single column system) of the tensile tester. The coatings were clamped to the base of the tester which was equipped with a horizontal translator in accordance with the ASTM F2255, F2256, F2258 and F2458 test standards. The tape experiments were repeated four to five times and at the end of each test the adhesive layer of the removed tapes were inspected via microscopy to see if any debris from the surface was transferred to the adhesive layer. Contact angle and hysteresis measurements were made on these regions of coatings where the tapes were removed immediately after the peel experiments.

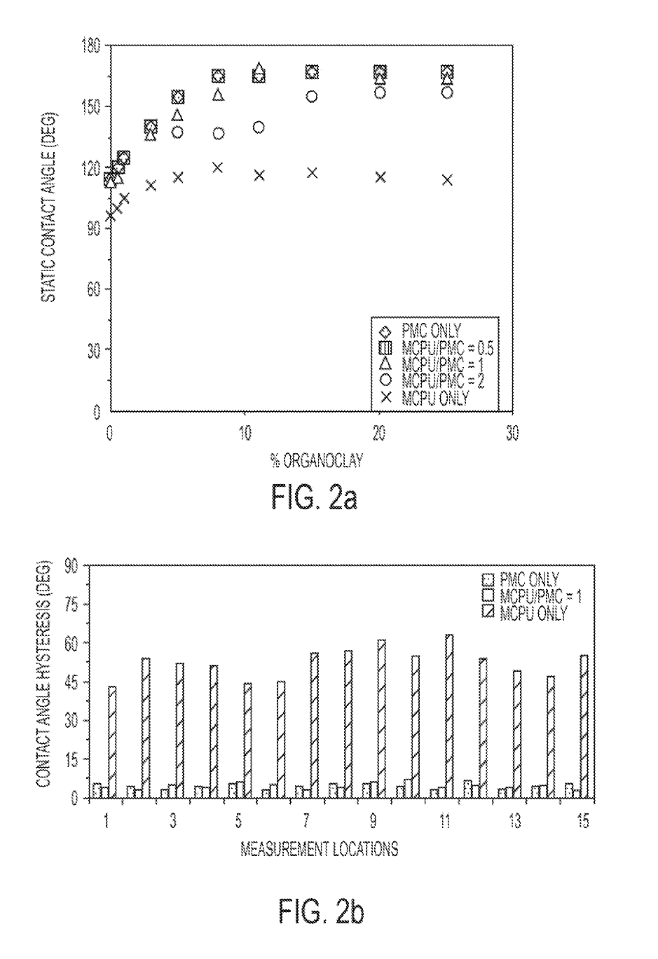

FIG. 2 depicts the approach is utilized to determine wettability performance. As shown in FIG. 2(a) the contact angle performance plateaus at 11% nanoclay weight concentration. A further examination of the data sets for different MCPU/PMC weight ratios in FIG. 1(a) reveals that introducing MCPU to the polymer matrix does not significantly reduce the contact angle until the weight ratio exceeds unity. FIG. 2(b) confirms that superhydrophobic performance is maintained at an MCPU/PMC weight ratio of unity with an average contact angle hysteresis value well below 10° throughout the surface area. It is also noted that a composite deprived of the low surface energy PMC component exhibited an average contact angle hysteresis much greater than 10° as well as a contact angle well below 150°, evidence of the importance of the fluorinated component with respect to anti-wetting.

1.4 Adhesion Performance

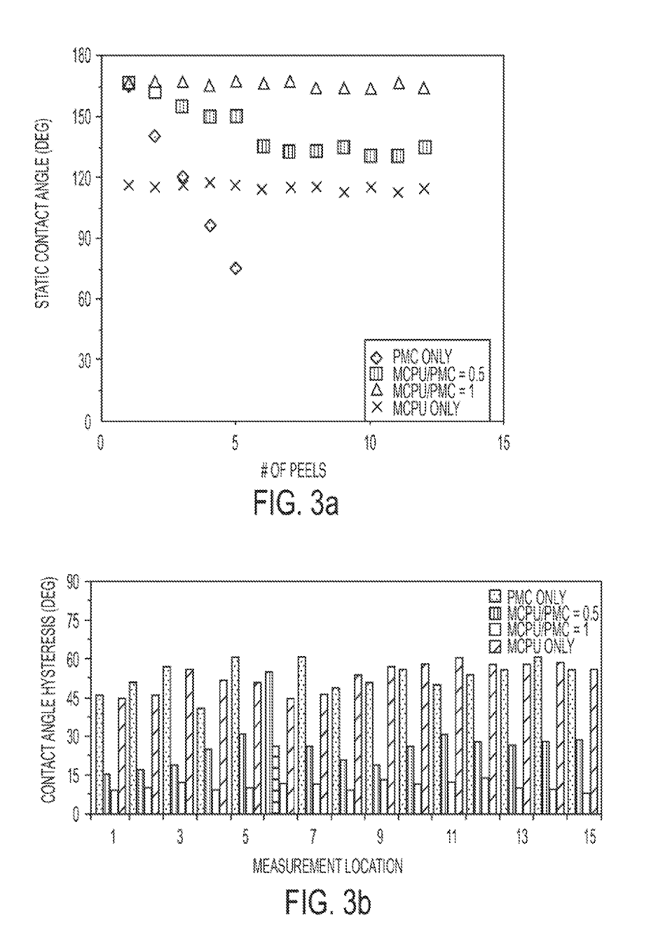

After determining the maximum MCPU concentration without compromising wettability performance, adhesion strength was investigated. The MCPU/PMC weight ratio was additionally varied and the new surfaces using coating compositions 1, 2, 3 and 5 in Table 1 were formed and tested. Twelve 1750 N/m tape tests for select MCPU/PMC weight ratios were carried out on a nanocomposite coating with 11% nanoclay weight concentration, i.e. sufficient nanoclay to reach the start of the contact angle plateau from FIG. 2(a). The results are plotted in FIG. 3. A negative slope can be observed in FIG. 3(a) for both a two-component coating composed of PMC binder and nanoclay filler as well as for a three-component coating composed of 0.5 MCPU/PMC ratio and nanoclay filler. This negative trend is evidence of the observation that the coating was peeling off the substrate during testing, leading to an anti-wetting performance degradation. However, MCPU/PMC ratio of 1.0 or higher (including pure MCPU) yielded a near zero slope in FIG. 3(a), which indicates that tape testing had a minimal effect on coating adhesion and wettability. The resulting average contact angle exceeding 160° over the span of tape testing for the 1.0 MCPU/PMC ratio composite suggests that this ratio is near optimal for the given components. FIG. 3(b) confirms that superhydrophobic performance is indeed maintained at this weight ratio and is suboptimal at other weight ratios tested with respect to contact angle hysteresis. Accordingly, a 1.0 MCPU/PMC ratio with 11% nanoclay weight concentration was used for further analysis.

1.5 Surface Characterization

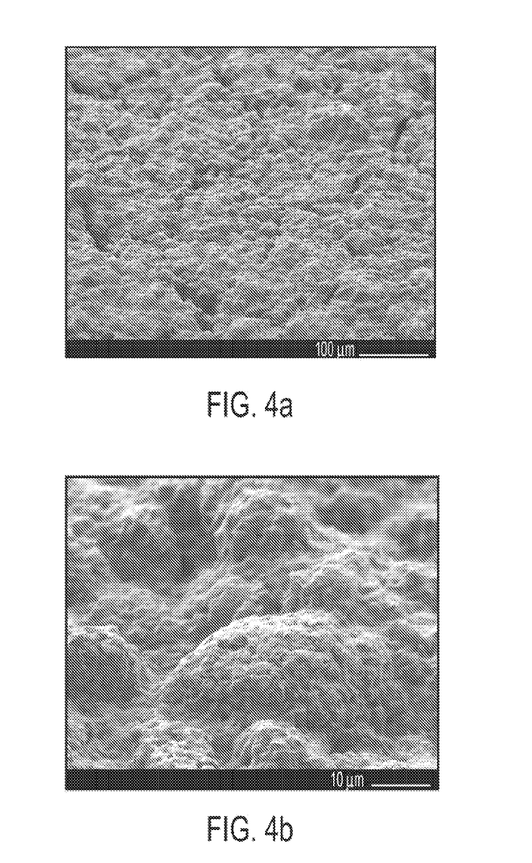

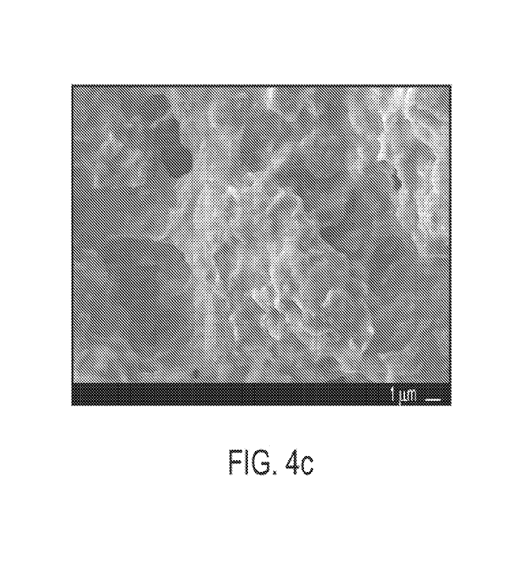

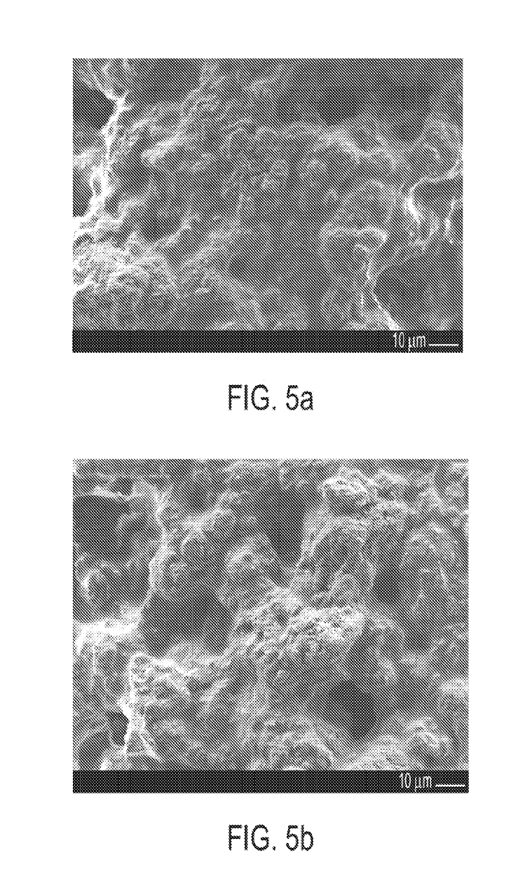

Detailed SEM observations indicated that the assembly process of the nanoclay along the coating surface during polyurethane crosslinking resulted in the formation of hierarchical surface roughness features as shown in FIG. 4. The nanocomposite surface morphology of FIG. 4(a) shows a remarkable resemblance to self-cleaning superhydrophobic lotus leaf topology shown throughout the literature.³¹ Higher magnification SEM images of these surfaces clearly indicate the existence of self-similar micron-sized bumps with unique sub-micron-sized surface roughness from the nanoclay particles as shown in FIGS. 4(b) and 4(c). Furthermore, after tape testing, SEM imaging revealed that the surface structure remained essentially unchanged as shown in the representative images of FIG. 5. FIG. 5(a) was captured from a sample before tape testing and FIG. 5(b) was captured from a sample after the twelfth tape test for an adhesion strength of 3850 N/m. Although the images were not captured at the exact same location on the sample, it was clear from careful inspection throughout the surface area that there was no discernible average morphological difference on the sample for each tape strength tested. Additional SEM analysis of the tapes tested on this MCPU/PMC/nanoclay nanocomposite did not reveal an observable amount of coating material that may have been removed from the surface during testing.

1.6 Backscattered Electron Analysis

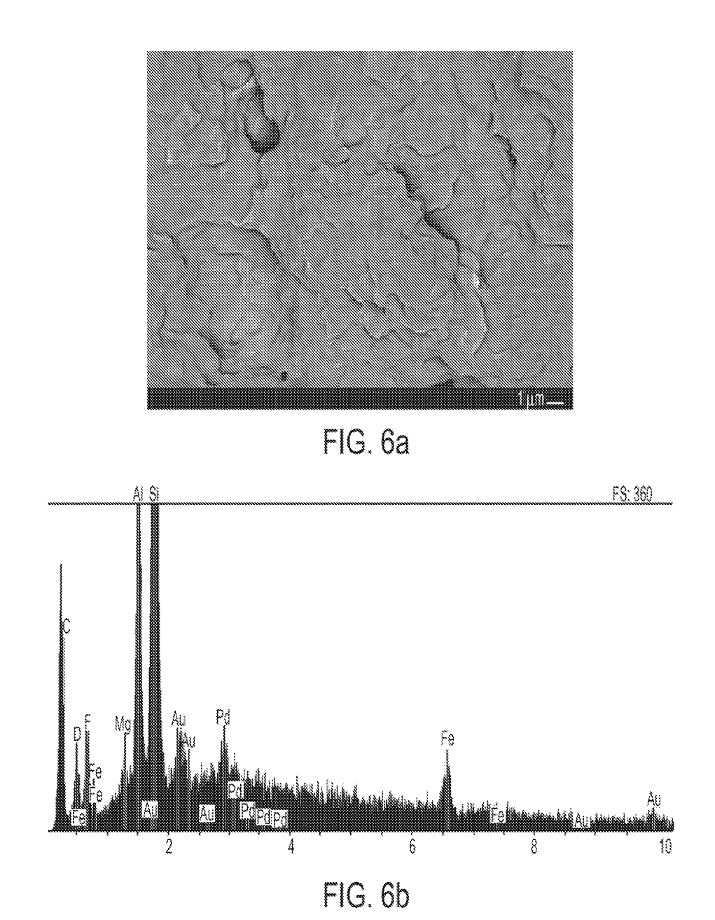

Further investigation into the composition of the coating was conducted with backscattered electron analysis. Originating from the electron beam, backscattered electrons comprise high-energy electrons that are reflected (i.e. back-scattered) due to elastic scattering interactions with atoms in the sample. FIG. 6(a) shows an SEM image formed from backscattered electron detection of a typical nanocomposite coating with 11% nanoclay weight concentration and a 1:1 weight ratio of MCPU and PMC. Since heavy elements with a high atomic number backscatter electrons more strongly than light elements with a low atomic number, and thus appear brighter in the image, backscattered electrons can be used to detect contrast between areas with different chemical compositions. It is clear in FIG. 6(a) that the relatively low contrast image with no significant bright areas indicates a coating with a relatively uniform chemical composition. The chemical composition is confirmed with energy dispersive spectroscopy analysis as shown in FIG. 6(b). Fluorine, carbon and oxygen from the PMC and MCPU; aluminum silicates with iron and magnesium from the nanoclay; as well as gold/palladium from the sputter coating for conduction in the SEM are all present in the chemical composition as expected.

1.7 High Adhesion Testing

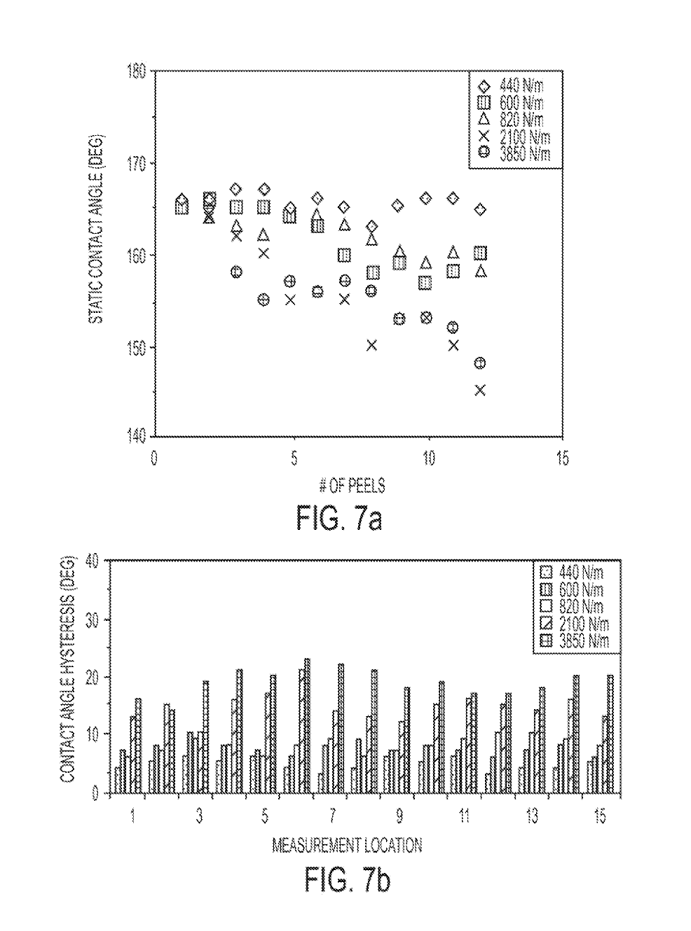

Higher adhesion strength tape tests up to 3850 N/m were also conducted as shown in FIG. 7. A superhydrophobic state was undoubtedly maintained up to 820 N/m over the span of the experiment; however, the data sets for tapes with an adhesion strength of 2100 N/m and 3850 N/m resulted in a slightly negative slope in FIG. 7(a). After the twelfth tape test, the contact angle degraded from above 160° to within a few degrees of 150° and the contact angle hysteresis increased slightly above 10°. Thus, even though it was observed that these tapes with the highest adhesion strength did not peel off a noticeable portion of the coating, the surface was disturbed enough to slightly degrade anti-wetting performance down to the superhydrophobic threshold. Since it was determined with SEM analysis that the surface morphology was not appreciably altered during tape tests, it is probable that the surface chemistry was slightly altered by the stronger tapes over repeated contact and trace amounts of hydrophilic tape material were deposited on the surface.

1.8 Conclusions

Substrate adhesion was investigated for superhydrophobic coatings of the invention fabricated from polyurethane modified with waterborne perfluoroalkyl methacrylic copolymer and a montmorillonite nanoclay filler. An initial static water contact angle of 167° and an average contact angle hysteresis of 4° were measured on the optimized MCPU-modified coatings, yielding anti-wetting and self-cleaning characteristics. A superhydrophobic nanocomposite formulation of about 10-12 wt % (11 wt %) nanoclay weight concentration and a 1:1 weight ratio of MCPU and PMC was found to result in strong adhesion to the aluminum substrate without a significant degradation of anti-wetting performance. Higher weight ratios of MCPU were observed to reduce anti-wetting performance before and after tape testing, where as higher weight ratios of PMC were observed to reduce anti-wetting performance after tape testing. High contact angles above 160° and low contact angle hysteresis below 10° could be completely retained under 1750 N/m adhesion strength tape testing. Significant resistance was also observed as high as 3850 N/m, which is higher than any reported superhydrophobic coating to the inventors' knowledge. Furthermore, 3850 N/m tape testing did not noticeably alter the coating surface morphology or remove an observable portion of the coating.

### Example 2

### Temperature and Humidity Effects on Superhydrophobicity of the Nanocomposite Coatings of the Invention

2.1 Measurement of Static Water Contact Angle (CA) and Roll-off Angles (ROA)

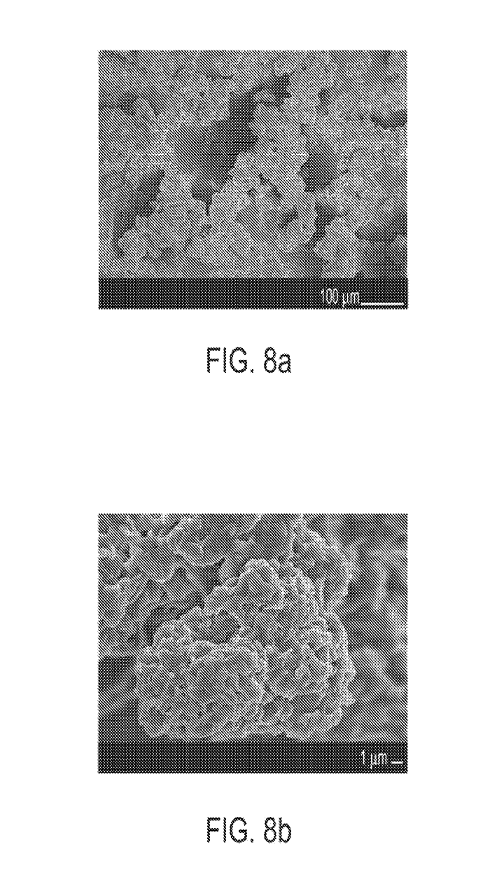

This example systematically measure the static water contact angle (CA) and the roll-off angle (ROA) of a superhydrophobic polyurethane/nanoclay nanocomposite surface for a full temperature cycle from 20° C. to −3° C. and back to 20° C. at both low and high humidity conditions while maintaining homogeneous thermal conditions (equal air, nanocomposite surface and water temperatures) at each point of measurement (every 5° C.) within the specified temperature cycle. The nanocomposite coatings were created as described in Example 1. Coating composition 3 was used. The coating compositions were then spray-casted onto aluminum substrates using an internal mix, double-action airbrush atomizer (model VL-SET, Paasche). The substrates were coated with a single spray application from a distance of approximately 30 cm above the substrate for a “dry” spray and then heat cured at 100° C. overnight to form a 100 μm thick superhydrophobic coating. Scanning electron microscope (SEM) images of the resulting nanostructures are shown in FIG. 8.

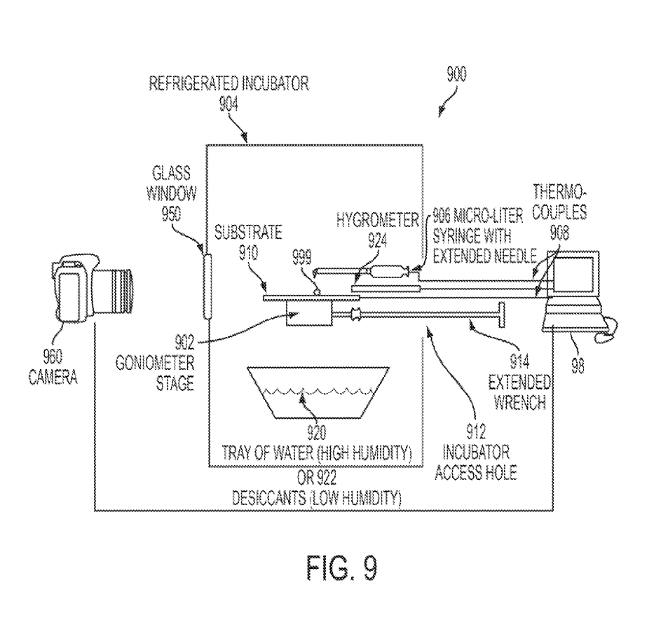

As shown further in the system 900 of FIG. 9, the nanocomposite substrate 910 was fixed to a manual goniometer stage 902 (GN-05, Thorlabs) and placed within a refrigerated incubator 904 (MIR-154, Sanyo) through incubator access hole 912 using an extended wrench 914. The refrigerated incubator 904 has a temperature range of −10° C. to 60° C. with an accuracy of ±1.5° C. This setup, together with a 2 ml syringe 906 (GS-1200, Gilmont) and thermocouples 908 (5SRTC Type T, Omega) on the substrate 910 and syringe 906, ensured that the incubator 904 was able to provide a thermally homogeneous condition for the substrate 910, air and water. For high relative humidity levels, a tray of water 920 was placed in the incubator 904 chamber while desiccants 922 (DX0017, EMD Chemicals) were used to reduce the relative humidity. Relative humidity levels were monitored using a hygrometer 924 (Model 4185, Control Company), accurate to within ±2% RH. To ensure proper mixing of air moisture within the incubator 904 chamber, an independent humidity measurement at different chamber locations were conducted. Results showed less than 1% RH spatial variation within the incubator 904 chamber. The RH spatial variations were small and not quantifiable with the instrumentation used.

At each temperature/humidity point in the cycle, a 104 water droplet 999 was deposited on the surface of the nanocomposite substrate 910 with the syringe 906. Averaged water droplet ROAs were obtained by simply tilting the goniometer stage 902 while averaged CA measurements were performed by capturing images of the water droplet 999 on the surface of the nanocomposite substrate 910 through the incubator glass window 950 using a digital SLR camera 960 (Canon T2i, MP-E 65 mm macro lens) and analyzed using a B-spline snake approach developed by Stalder et. al.⁴⁴ in computer system 980. The entire data acquisition process was repeated for every 5° C. until a temperature cycle (20° C. to −3° C. to 20° C.) was completed. In addition, care was exercised to ensure that the humidity levels at temperatures during the warming cycle (−2° C. to 20° C.) closely resembled the humidity levels acquired during the cooling cycle (20° C. to −2° C.).

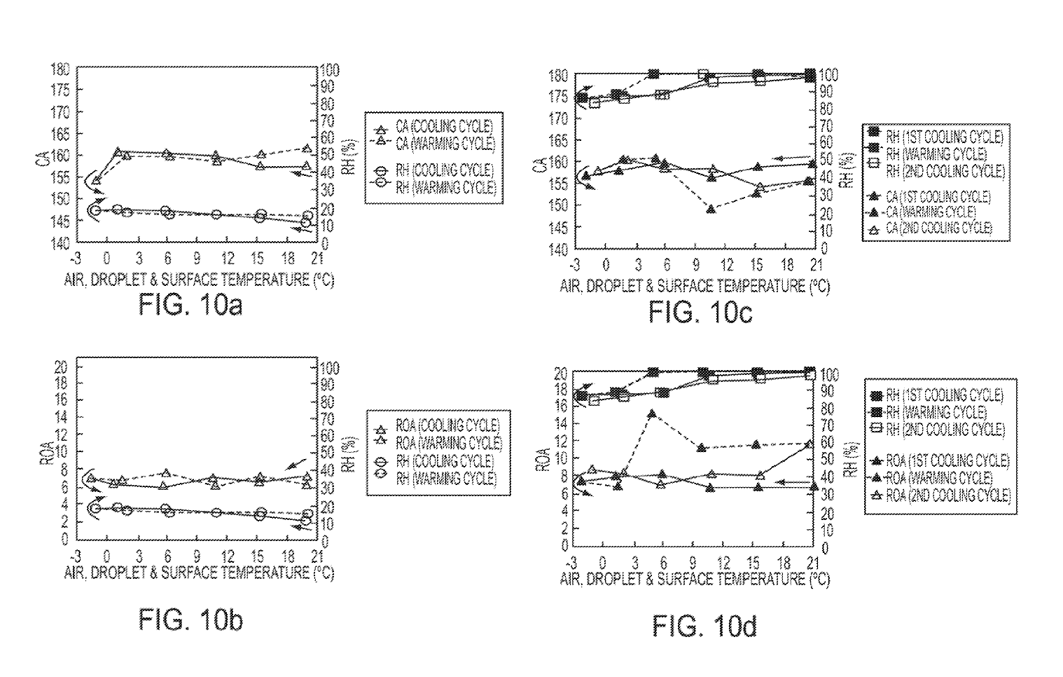

The averaged CA results of the low humidity experiment are shown in FIG. 10(a) with the arrow representing the initial direction of the temperature cycle. It can be seen that the relative humidity levels were consistently maintained below 20% throughout the entire temperature cycle and the CAs remained constant at approximately 160° as the temperature was reduced from 20° C. to 0° C. Once below 0° C., the CA measurement decreased slightly to 154°. During the warming cycle, CAs remained close to the measurements from the cooling cycle with no sign of path divergence. This indicates that humidity history effects were negligible. FIG. 10(b) shows that the averaged ROA across the temperature cycle also remained constant. Thus, the low humidity result indicated that superhydrophobicity was retained at low humidity conditions (RH<20%) over a wide range of surface/air temperatures. Under high humidity conditions (RH>80%) and as shown in FIGS. 10(c) and 10(d), the nanocomposite surface also maintained similar levels of superhydrophobicity with nearly constant CA and ROA values as temperature was reduced from 20° C. to −3° C. These trends are substantially different than those of Yin et. al.⁷, Karmouch et. al.⁸, He et. al.¹⁵ and Yin et. al.¹⁶ who found marked reductions in CA and CAH angles as surface temperature was reduced for both low and high humidity environments.

2.2 Effect of Homogeneous Versus Non-homogeneous Thermal Conditions on Superhydrophobicity

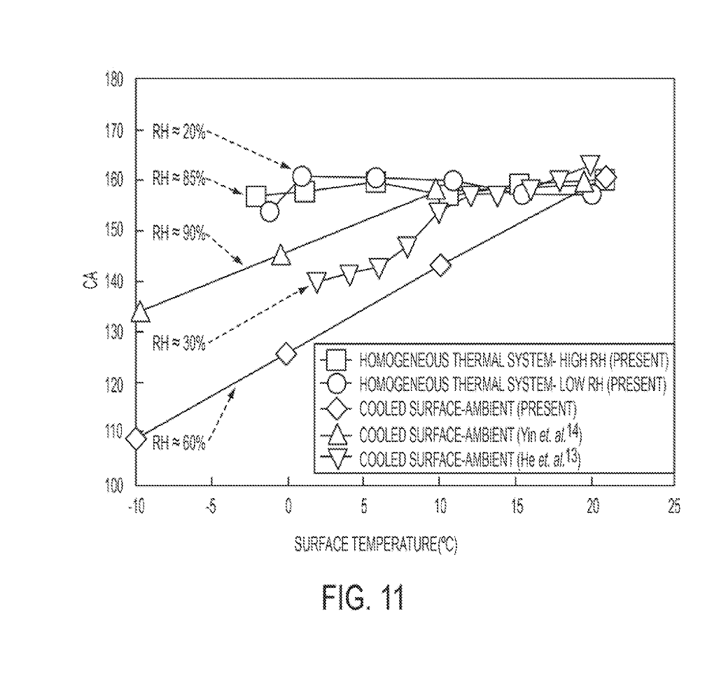

To understand the differences between the present high humidity results from the cooling cycle and those of Yin et. al.⁷, Karmouch et. al.⁸, He et. al.¹⁵ and Yin et. al.¹⁶, an additional experiment was performed. A Peltier cooling stage was set up to investigate the effect of homogeneous versus non-homogeneous thermal conditions on superhydrophobicity. To create a non-homogeneous thermal system, room temperature water droplets were placed on gradually cooled surfaces exposed to open environment (Tₐᵢᵣ=22° C., RH=60%) while CAs were measured. As shown in FIG. 11, CAs decreased dramatically from 160° to 108° when the surface temperature was reduced from 20° C. to −10° C. at room temperature. In this case, when the surrounding air and droplet temperatures were held fixed, cooling the surface with the Peltier stage resulted in condensation, which was observed to significantly decrease the superhydrophobicity of the nanocomposite. This was in contrast to the cooling cycle in the incubator, where CAs remained fairly constant as temperatures of the nanocomposite, air and water droplet were homogeneously controlled by the chamber temperature even at a relative humidity over 85%. This indicates that regardless of humidity levels, surface superhydrophobicity was generally not degraded as surface temperature decreased. Instead, superhydrophobic degradation was associated to condensation effects generally triggered by non-homogeneous thermal conditions, which caused wetting transitions from Cassie to Wenzel state.

Degradation in superhydrophobicity was observed during the warming cycle (from −3° C. to 20° C.) of the high humidity experiment. As shown in FIGS. 10(c) and 10(d), while the first few points of measurement in the warming cycle closely resembled the values previously acquired in the cooling cycle, the superhydrophobicity of the nanocomposite decreased above 5° C. In particular, the ROA increased by a factor of two. This divergence from the cooling cycle measurements was coupled with: 1) visual appearance of condensation in the incubator and 2) a change in direction of the slight imbalance between air and nanocomposite surface temperature. The slight imbalance (measured to be an average of 2° C.) results because the surface temperature lags behind the air temperature due to thermal inertia from the aluminum substrate, hence creating a slight non-homogeneous thermal system. In particular, the surface temperature (for RH≈85%) was above the air dew point for the first two points of the warming cycle which is consistent with the absence of condensation. However, at the third point of measurement, the imbalance between the surface and air temperature widened with the surface temperature dipping slightly below the air dew point. This result strongly suggests that condensation is the cause for the decrease in superhydrophobicity. In general however, the surface and air temperature equilibrated in about 35 minutes. To assess any additional humidity history effects after the warm up cycle, a second cooling cycle was also conducted from 20° C. to −3° C. a few hours after the completion of the warm-up cycle. It was observed that the previously condensed water from the warming cycle evaporated off the surface by this time. As seen in FIGS. 10(c) and 10(d), no additional humidity history effects were found, i.e. superhydrophobicity resumed on the surface at CAs and ROAs consistent with the first cooling cycle. Thus it is hypothesized that condensation effects, which result in the change from Cassie to Wenzel wetting state, are reversible.

2.3 Conclusion

The superhydrophobicity of the nanocomposite coatings of the invention was maintained for a full temperature cycle of 20° C. to −3° C. in a low humidity environment, when at each point of the temperature cycle, the superhydrophobic nanocomposite, air and water droplet remained thermally homogeneous. Comparable results were also observed for the cooling cycle of a thermally homogeneous, high humidity test. These results differed from those obtained from open environment experiments where only the substrate was cooled while the air and water droplet were fixed at room temperature. Even small differences between the air and nanocomposite surface caused condensation which led to superhydrophobic degradation, especially at high humidity during a warming cycle.

### Example 3

### Impact of Spray-Casting Height and Pressure

3.1 Nanocomposite Coating Fabrication

Precursor solutions were first created, followed by spray casting and then thermosetting to produce the final nanocomposite coatings as described in Example 1 with the following differences. First, polyurethane was dispersed in acetone. The polyurethane was Imron AF3500 product, a polyester-aliphatic/isocyanate polyurethane available from DuPont. Next, as-received dimethyl dialkyl C₁₄-C₁₈ amine functionalized montmorillonite clay particles (Nanoclay, Nanocor Inc., USA) were dispersed in the polyurethane-acetone mixture. Finally, waterborne fluorinated acrylic copolymer (25% wt polymer, 75% wt water; Dupont) was added slowly to the polyurethane-nanoclay suspension and blended with vortex mixing for 15 minutes, creating a Pickering emulsion. To further promote homogeneity in the solution, the slurry was sonicated at 35% amplitude at a frequency of 20 khz for two minutes with an ultrasonicator (Model VC750, Sonics & Materials, Inc., USA) Additional solvent (acetone) was added as necessary into the sonicated solution to reduce the viscosity of the mixture.

To create the nanocomposite coatings from this precursor solution, the slurries were spray-casted onto aluminum substrates from various spray-casting heights and air pressures and then heat cured at 100° C. overnight.

3.2 Spray-casting System Set-Up and Process

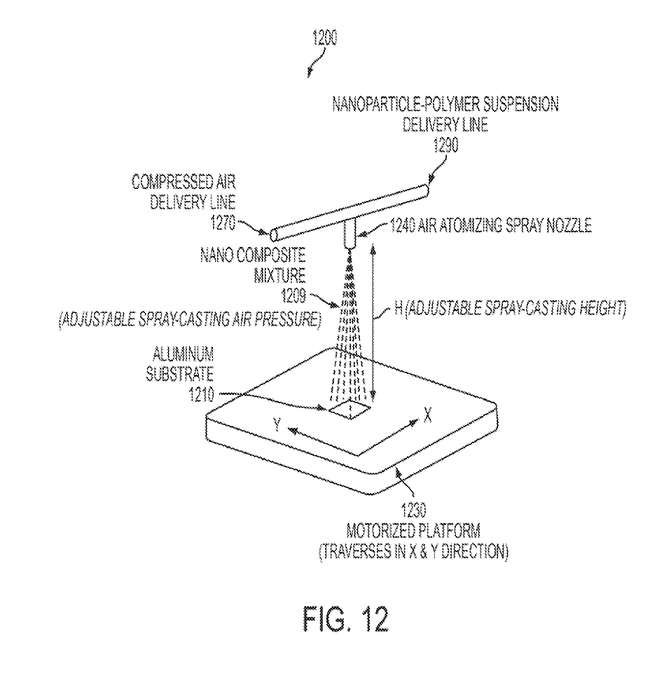

To ensure consistency in the spray-casting process and ultimately in the quality of the nanocomposite coatings, the aluminum substrate 1210 was placed on a motorized platform 1230 and translated in controlled longitudinal (Y axis) and lateral (X axis) motions while the air-atomizing nozzle 1240 sprayed the nanocomposite mixture 1209 above the platform 1230 as shown in a spray-casting system 1200 in FIG. 12. The motorized platform 1230 was controlled by two linear slides (not shown separately) driven by stepper motors (Xslide, Velmex Inc., USA) (not shown separately). The air-atomizing spray nozzle 1240 was an internal mix model (1/4JCO series, Spray Systems Co., USA) with a round spray pattern and with the capacity of approximately 0.75 gallons/hr at 40 psi air pressure. Regulated air pressure was provided via compressed air delivery line 1270 by an external air compressor (3 hp, Craftsman) (not shown separately) while the polyurethane-nanoclay slurry was siphoned into the spray nozzle via nanoparticle-polymer suspension delivery line 1290.

The spray-casting process began when the air-atomizing nozzle 1240 was set at a fixed height H above the substrate 1210 to deliver a fine mist of polymer-nanoclay mixture droplets 1209. The motorized platform 1230 was then programmed to step in the lateral direction (X axis) for a distance of 0.2 inches before traversing in the longitudinal direction at a speed of 6 inches/second.

The programmed motion was repeated until the entire substrate 1210 was coated. Various spray heights (1-6 inches) H and air pressures (20-100 psi) delivered via compressed air delivery line 1270 were used to create different nanocomposite coatings for quantitative super-hydrophobic and mechanical durability measurements.

Static water CA measurements were performed as outlined above with regard to FIG. 9 by capturing three digital images of a water droplet (10 μl diameter) through a digital SLR camera (Canon EOS T2i, macro lens MP-E). The images were then analyzed using a B-spline snake approach pioneered by Stalder et al.⁴⁴ as a plug-in program within the Image-J software to provide an averaged CA measurement. Roll-off angles were acquired by measuring the tilt angle of the coating where a 10 μl water droplet would slide off the surface. ROA measurements were also repeated five times so that an averaged ROA value could be acquired.

To assess the mechanical durability of the coatings, a linear abraser (Model 5750, Taber Industries) was used. This device consisted of an abradant tip attached to a horizontal arm which reciprocated in a linear fashion at a force determined by weight discs. The abradant tip (H-10 Calibrade, Taber Industries) was made of aluminum oxide abrasive particles designed to provide medium abrasive action. 900 g of weight discs were placed on the arm and the nanocomposite surfaces were abraded until the point of coating break-through. Coating break-through was defined as the point where the abradant tip completely wears the coating at which the surface of the underlying aluminum substrate was visible.

3.3 Effect of Spray-Casting Height on the Superhydrophobicity of Nanocomposite Coatings

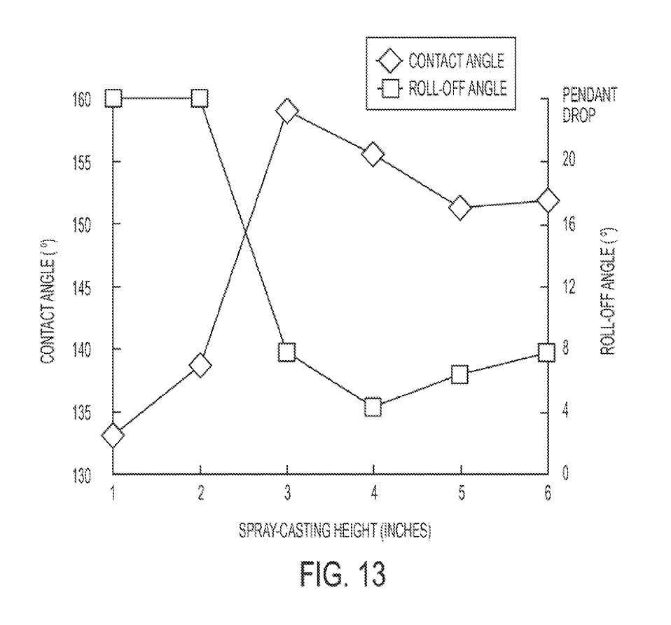

FIG. 13 shows the effect of spray-casting height on the superhydrophobicity of the coatings when spray-casting air pressure was fixed at 60 psi. It can be observed that nanocomposite coatings fabricated at less than or equal to 2 inch spray-casting heights were not superhydrophobic. Static water CA angles did not exceed 140° and roll-off angle measurements resulted in a pinned droplet on the surface. However, at 3 inch spray-casting heights, the superhydrophobic performance of the coatings improved tremendously. Static water CA increased to nearly 160′ with a ROA of approximately 8°. Further increase of the spray-casting height showed that coatings remained superhydrophobic, albeit with a slight drop-off in superhydrophobicity.

This effect can be explained by considering the mechanism of nanocomposite formation by spray atomization. After atomization, the nanoclay-polymer suspension travels through air from the nozzle to the substrate in the form of droplets. Each of these droplets contain solvent which acts as a medium of transport while evaporating during the time of flight, leaving mainly nanoclay and polymer components on the substrate to form a nanocomposite coating. The degree of evaporation is however linked to the height between the spray nozzle and substrate.

For a low spray-casting height, there is insufficient time for the solvent to evaporate, therefore creating a “wet” coating on the substrate. This leads to the “coffee stain” effect⁴⁵ which causes non-uniform coatings through surface tension effects. Therefore, this results in a decrease in superhydrophobicity. On the other hand, at higher spray-casting heights, most of the solvent evaporates during time of flight, leaving a high concentration of nanoclay and polymer components on the substrate to form a more porous nanocomposite coating with hierarchal nanotextured surface morphology and with high superhydrophobicity.

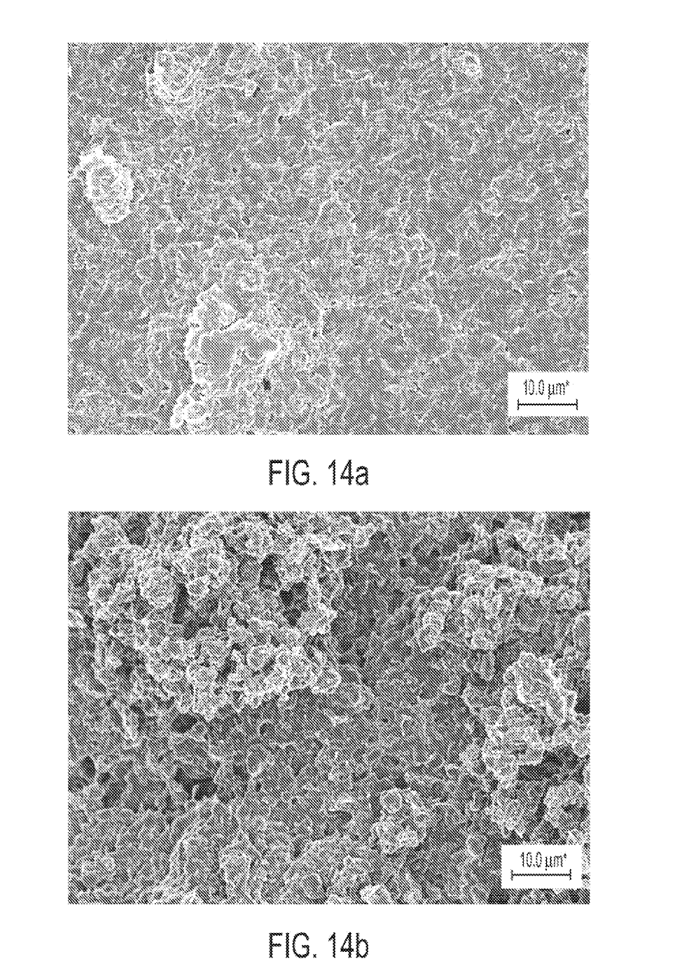

Scanning electron microscope (SEM) images were acquired for coatings spray-casted at heights of 2 and 3 inches to demonstrate this effect. For a spray height of 2 inches shown in FIG. 14a, a “flat” surface texture was observed. In comparison, the SEM image of a surface coated at a height of 3 inches depicted more texture at different length scales (FIG. 14b).

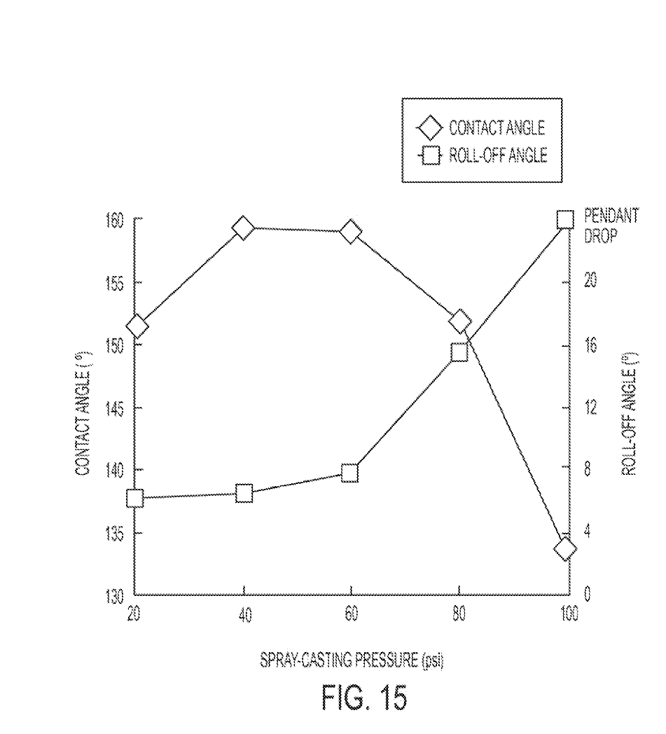

FIG. 15 shows the effect of spray air pressure on the superhydrophobicity of the coatings when spray height was fixed at 3 inches. It can be observed that at spray-casting air pressures between 20 and 60 psi, the nanocomposite remained superhydrophobic with static water CA between 151° and 159° with ROA less than 8°. However, superhydrophobic performance degraded at a spray-casting air pressure of 80 psi with a complete loss of superhydrophobicity for coatings fabricated at an air pressure of 100 psi.

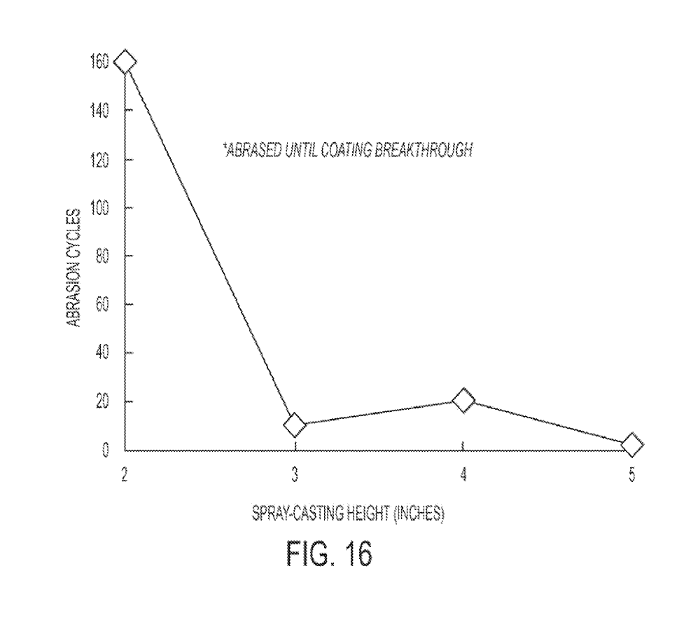

FIG. 16 shows the mechanical durability of the nanocomposite coating at different spray-casting heights while fixed at an air atomizing pressure of 60 psi. The fabricated coating at 2 inch spray-casting height was able to resist 160 cycles before a breakthrough of the coating was detected. However, increasing the spray-casting height above 2 inches resulted in a significant degradation in coating mechanical durability. This effect corresponds with the hypothesis that a “wet” coating from a low spray height is mechanically stronger than a porous coating fabricated from a higher spray height.

3.4 Effect of Spray-Casting Pressure on the Superhydrophobicity of Nanocomposite Coatings

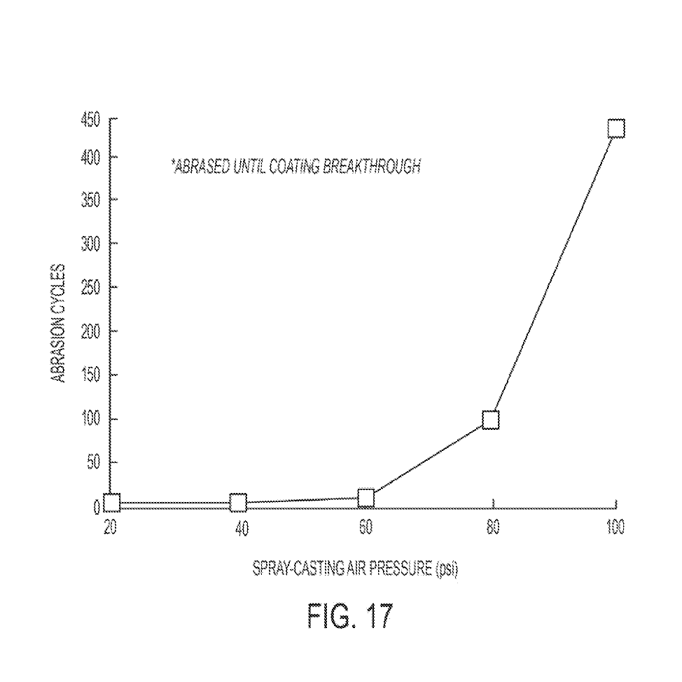

Nanocomposite coatings were fabricated at different spray-casting air pressures while fixed at a 3 inch spray-casting height. Results in FIG. 17 showed that coatings fabricated at higher pressures demonstrated remarkable resistance to abrasion since a higher volume of slurry was delivered by the spray nozzle to the substrate to create a “wet” coating. In comparison, coatings fabricated at low spray pressures were more porous and therefore mechanically more fragile.

3.5 Conclusions

Spray-casting height and air pressure affects the superhydrophobicity and durability of polyurethane-nanoclay nanocomposite coatings. The results indicate that coatings manufactured from a high spray-casting height were superhydrophobic. However, at low spray-casting heights, the “coffee stain effect” was observed, hence dramatically reducing the hydrophobicity of the coating. A similar reduction in superhydrophobicity was observed with high spray-casting air pressures where a high volume of nanoclay-polymer mixture was delivered to the substrate to form a “wet” coating. Although lacking in hydrophobicity, these “wet” coatings provided a remarkably higher resistance towards mechanical abrasion as compared to a more porous coating fabricated from a higher spray-casting height or lower air pressure.

### REFERENCES

The disclosure of the references cited herein are incorporated by reference—those listed below and those discussed elsewhere in this specification.
1. D. K. Chattopadhyay and K. V. S, N. Raju, Progress in Polymer Science, 32, 352-418 (2007).
2. S. A. Madbouly and J. U. Otaigbe, Progress in Polymer Science, 34, 1283-1332 (2009).
3. L. Cao, A. K. Jones, V. K. Sikka, J. Wu and D. Gao, Langmuir 25(21), 12444 (2009).
4. S. A. Kulinich and M. Farzaneh, Appl. Surf. Sci. 255, 8153 (2009).
5. L. Mishchenko, B. Hatton, V. Bahadur, J. A. Taylor, T. Krupenkin and J. Aizenberg, ACS Nano 4(12),7699 (2010).
6. A. Meuler, J. David Smith, K. Varanasi, J. Mabry, G. McKinley and R. Cohen, ACS Appl. Mater. Interfaces 2(11), 3100 (2010).
7. L. Yin, Q. Xia, J. Xue, S. Yang, Q. Wang and Q. Chen, Appl. Surf. Sci. 256, 6764 (2010).
8. R. Karmouch and G. G. Ross, J. Phys. Chem. C 114, 4063 (2010).
9. B. Mockenhaupt, H-J Ensikat, M. Spaeth and W. Barthlott, Langmuir 24, 13591 (2008).
10. A. B. D. Cassie and S. Baxter, Trans. Faraday Soc. 40, 546 (1944).
11. R. N. Wenzel, Ind. Eng. Chem. 28, 988 (1936).
12. T. Furuta, M. Sakai, T. Isobe and A. Nakajima, Langmuir 26(16), 13305 (2010).
13. C—H, Chen, Q. Cai, C. Tsai, C-L. Chen, G. Xiong, Y. Yu and Z. Ren, Appl. Phys. Lett. 90, 173108 (2007).
14. C. Dorrer and J. Ruhe, Adv. Mater. 20, 159 (2008).
15. M. He, H. Li, J. Wang and Y. Song, Appl. Phys. Lett. 98, 093118 (2011).
16. L. Yin, L. Zhu, Q. Wang, J. Ding and Q. Chen, ACS Appl. Mater & Interfaces 3, 1254 (2011).
17. M. Ma and R. M. Hill, Colloid and Interface Sci. 11, 193, 2006.
18. X. Feng and L. Jiang, Adv. Matter 18, 3063, 2006.
19. A. Steele, I. Bayer and E. Loth, Nano Lett. 9(1), 501, 2009.
20. T. Schutzius, M. Tiwari, I. Bayer and C. Megaridis, Composites Part A 42, 979, 2011.
21. J. Yang, Z. Zhang, X. Men and X. Xu, Appied Surface Sci. 255, 9244, 2009.
22. H. Ogihara, J. Okagaki and T. Saji, Langmuir 27, 9069, 2011.
23. L. Hong and T. Pan, J. Microelectromech. Syst. 19(2), 246, 2010.
24. X. Xu, Z. Zhang, F. Guo, J. Yang, X. Zhu, X. Zhou and Q. Xue, J. Bionic Engr. 9, 11, 2012.
25. V. Eigenbrod, C. Hensch and H. K. Pulker, Vakuum in Forschung and Praxis 23(6), 24, 2011.
26. D. M. Wu, W.; van Benthem, R.A.T.M.; de With, G., Journal of Adhesion Science and Technology, 22, 1869-1881 (2008).
27. W. Wu, Q. Zhu, F. Qing and C. C. Han, Langmuir, 25, 17-20 (2008).
28. W.-H. Chen, P.-C. Chen, S.-C. Wang, J.-T. Yeh, C.-Y. Huang and K.-N. Chen, Journal of Polymer Research, 16, 601-610-610 (2009).
29. J. Feng, B. Huang and M. Zhong, Journal of Colloid and Interface Science, 336, 268-272 (2009).
30. J. Zhang, W. Huang and Y. Han, Macromolecular Rapid Communications, 27, 804-808 (2006).
31. X. J. Feng and L. Jiang, Advanced Materials, 18, 3063-3078 (2006).
32. S. H. Kim, Journal of Adhesion Science and Technology, 22, 235-250 (2008).
33. K.-C. Chang, H. Chen, C.-K. Huang and S.-I. Huang, Journal of Applied Polymer Science, 104, 1646-1653 (2007).
34. Z. Yuan, H. Chen, J. Tang and D. Zhao, Journal of Applied Polymer Science, 113, 1626-1632 (2009).
35. Q. F. Xu, J. N. Wang and K. D. Sanderson, Journal of Materials Chemistry, 20, 5961-5966 (2010).
36. O.-u. Nimittrakoolchai and S. Supothina, Macromolecular Symposia, 264, 73-79 (2008).
37. E. J. Lee, J. J. Kim and S. O. Cho, Langmuir, 26, 3024-3030 (2010).
38. I. S. Bayer, A. Steele, P. J. Martorana and E. Loth, Applied Surface Science, 257, 823-826 (2010).
39. I. S. Bayer, A. Steele, P. Martorana, E. Loth, S. J. Robinson and D. Stevenson, Applied Physics Letters, 95, 063702-063703 (2009).
40. C.-F. Wang, W.-Y. Chen, H.-Z. Cheng and S.-L. Fu, The Journal of Physical Chemistry C, 114, 15607-15611 (2010).
41. O. B. Robert D. Deegan, Todd F. Dupont, Greb Huber, Sidney R. Nagel, Thomas A. Witten, Nature, 389, 827-829 (1997).
42. J. Kim, J. Cho and Y.-S. Lim, Journal of Materials Science, 40, 2789-2794 (2005).
43. A. Steele, I. Bayer and E. Loth, Nano Letters, 9, 501-505 (2008).
44. A. F. Stalder, G. Kulik, D. Sage, L. Barbieri and P. Hoffmann, Colloids and Surfaces A 286, 92 (2006).
45. R. D. Deegan, O. Bakajin, T. F. Dupont, G. Huber, S. R. Nagel and T. A. Witten, Nature 389, 827, 1997.

1. A superhydrophobic coating composition comprising:
about 5 to about 60 weight percent of a polyurethane,
about 5 to about 60 weight percent of a fluoropolymer,
about 5 to about 50 weight percent of a nanofiller,
about 25 to about 99 weight percent of an organic solvent, and
up to about 15 weight percent water,
wherein the polyurethane and the fluoropolymer are present in a weight ratio from about 1:2 to about 15:1.

2. A superhydrophobic coating composition of claim 1, wherein:
the polyurethane is a moisture-cure polyurethane,
the fluoropolymer is selected from a perfluoroalkyl acrylic (co)polymer, a perfluoroalkyl methacrylic (co)polymer and mixtures thereof,
the nanofiller is selected from clay particles, metallic particles, oxides, carbon particles synthetic particles or mixtures thereof, and
the organic solvent is selected from ethanol, isopropanol, acetone, ethyl acetate and mixtures thereof.

3. A superhydrophobic coating composition of claim 1, comprising:
about 10 to about 20 weight percent of the polyurethane,
about 10 to about 20 weight percent of the fluoropolymer,
about 5 to about 30 weight percent of the nanofiller,
about 50 to about 75 weight percent of an organic solvent, and
about 5 to about 10 weight percent water.

4. A superhydrophobic coating composition of claim 1, wherein the polyurethane and the fluoropolymer are present in a weight ratio of about 1:1 or of about 14:1.

5. A superhydrophobic coating composition of claim 1, wherein the nanofiller is a surface-treated nanofiller.

6. A superhydrophobic coating composition of claim 1, wherein the nanofiller is a selected from clay particles, silicon dioxide and mixtures thereof.

7. A coated substrate having at least a portion of one surface coated with a superhydrophobic coating comprising:
about 15 to about 80 weight percent of a polyurethane;
about 5 to about 80 weight percent of a fluoropolymer;
about 5 to about 40 weight percent of a nanofiller; and
wherein the polyurethane to fluoropolymer are present in a weight ratio from about 1:2 to about 15:1.

8. A coated substrate of claim 7, wherein the superhydrophobic coating has a static water contact angle above 150° and contact angle hysteresis value below 8°.

9. A coated substrate of claim 7, wherein;
the polyurethane is a moisture-cure polyurethane,
the fluoropolymer is selected from a perfluoroalkyl acrylic (co)polymer, a perfluoroalkyl methacrylic (co)polymer and mixtures thereof, and
the nanofiller is selected from clay particles, metallic particles, oxides, carbon particles synthetic particles or mixtures thereof.

10. A coated substrate of claim 7, wherein the polyurethane and the fluoropolymer are present in a weight ratio of about 1:1 or of about 14:1.

11. A coated substrate of claim 7, wherein the surface is a metal surface, a plastic surface, a glass surface, a natural polymer surface, a ceramic surface or a composite surface.

12. A coated substrate of claim 7, wherein the substrate is an airplane, a wind turbine, a marine vessel, a sign, a building or a bridge.

13. A method of forming a superhydrophobic coating on a surface of a substrate, comprising the steps of:
spraying a superhydrophobic coating composition of claim 1 onto a surface of a substrate to form a coating, and
curing the coating.

14. A method of claim 13, wherein the spraying step comprises spray-casting the superhydrophobic coating composition of onto a surface of a substrate.

15. A method of claim 14, wherein the spray casting is at an air pressure of about 20 to about 60 psi and from a height of about 3 to about 12 inches above the surface.

16. A method of claim 13, wherein the surface is a metal surface, a plastic surface, a glass surface, a natural polymer surface, a ceramic surface or a composite surface.

17. A method of claim 13, wherein the substrate is an airplane, a wind turbine, a marine vessel, a sign or a bridge.

18. A method of forming a superhydrophobic coating on a surface of a substrate, comprising the steps of:
spray casting a superhydrophobic coating composition onto a surface of a substrate to form a coating from a height of about 3 to about 12 inches above the surface to form a coating, and
curing the coating.

19. A method of claim 18, wherein the spray-casting is done with an ultrasonic nozzle or at an air pressure of about 20 to about 60 psi.

20. A method of claim 18, wherein the superhydrophobic coating composition comprises:
about 5 to about 60 weight percent of a polyurethane,
about 5 to about 60 weight percent of a fluoropolymer,
about 5 to about 50 weight percent of a nanofiller,
about 25 to about 99 weight percent of an organic solvent, and
up to about 15 weight percent water,
wherein the polyurethane and the fluoropolymer are present in a weight ratio from about 1:2 to about 15:1.
